(19) United States
(12) Patent Application Publication
(10) Pub. No.: US 2006/0036619 A1
(43) Pub. Date: Feb. 16, 2006

(54) Method for accessing and analyzing medically related information from multiple sources collected into one or more databases for deriving illness probability and/or for generating alerts for the detection of emergency events relating to disease management including HIV and SARS, and for syndromic surveillance of infectious disease and for predicting risk of adverse events to one or more drugs

(76) Inventors: Oren Fuerst, New York, NY (US); Tzameret Fuerst, New York, NY (US)

Correspondence Address: Eugene Lieberstein, Esq.;Anderson Kill & Olick, P.C., 1251 Avenue of the Americas, New York, NY, 10020, US

(21) Appl. No.: 11/198,588

(22) Filed: Aug. 4, 2005

Related U.S. Application Data
(60) Provisional application No. 60/606,711, filed on Sep. 2, 2004.
(60) Provisional application No. 60/599,775, filed on Aug. 9, 2004.

(51) Int. Cl. G06F 7/00

(52) U.S. Cl. 707/100

(57) ABSTRACT

The method of the present invention derives the illness probability of any selected person from a database of people stored in a computer and/or on a computer network using collected relational data from every person in the database, including whether a person has a contact relationship with another person in said database and utilizes a database of illnesses infection probability functions given different illnesses and states of nature including data relating to social relationship; type of disease; probability function of infection given a time unit; length of contact of the particular contact relationship link; and calculates at least one relational path between said person and each person in the data base with whom there is a contact relationship, direct or via other persons in the said database for deriving the illness probability of the selected person. In addition. the method of the present invention permits selecting the optimum treatment for a patient with an infectious disease based upon recommending a drug or drugs deemed optimum for treating the patient and permits generating alerts for the detection of emergency events such as the outbreak of an infectious disease or a biological, chemical or nuclear attack and for diseases management. Moreover, in accordance with the method of the present invention a given patient may compare his or her medical record with summary information of patients with similar defined criteria.

### FIELD OF THE INVENTION

The present invention is based upon the subject matter of provisional patent application 60/606,711 with filing date Sep. 2, 2004 and 60/599,775 with filing date Aug. 9, 2004 both incorporated herein by reference in their entirety and relates to a method of accessing medically related information and analysis for deriving illness probability and/or for generating alerts for the detection of emergency events relating to disease management and for predicting a risk of adverse events to one or more drugs and, more particularly, but without limitation, to a method for accessing, storing, retrieving, analyzing, reporting, tracking and alerting medical, environmental and additional data, by using a combination of centralized computer controlling a network of data entry and reporting access points.

### BACKGROUND OF THE INVENTION

The present invention is based upon the collection of information from multiple sources including clients, consumers, sensors, medical devices, medical institutions, governmental agencies and the facilitation and creation of information sharing platform, whereby medical and other records are being so collected and uploaded to electronically accessible locations particularly databases for processing to infer and detect emergency events such as the outbreak of an infectious disease or a biological, chemical or nuclear attack and for diseases management. The data captured may include various historical, medical, environmental and other criteria and reports, to generate alerts and reporting recommendations. The method may also provide for facilitation of telemedicine by enabling two-way communication, centralized management of medical and other information that may be stored or otherwise accessible by the system. The method may, in part, involve voluntary participation of consumers and patients, to capture data as part of daily routines, for example, the blood sugar level of consumers with diabetes, pulmonary data, blood pressure and ECG information. The system could also utilize signals aggregated from two way GPS systems (such as those in a variety of cellular phones). The system may also automatically collect information from sensors and gather information from medical facilities and practitioners as well as from municipalities, government agencies and other sources.

The method may allow for participation of patients and the other involved parties. Patients could compare the level and the changes of their medical conditions with those of their peers based on geographical location, age etc. The information could also initiate alerts when there is a deviation from a set benchmark for a particular patient, and the alert could be forwarded to a healthcare professional or other locations for follow-up.

In addition, the method could be used to allow for consumers to select disease management services and other telemedicine applications to subscribe to or buy, and the information captured could be forwarded to the services of the consumer's choice.

The method may also aggregate, automatically or manually, and examine medical, environmental and other data routinely collected by healthcare institutes, municipalities, government agencies, medical devices, clinical systems, and specifically designed sensors, in real time. It may then examine this data for trends and anomalies, suggestive of disease outbreaks including those who may be the result of a chemical, nuclear or biological attack, and present this information in an intuitive and decision-supportive manner that allows rapid assessment of threats in real-time and the coordination of an effective response.

The method associates probabilities of disease infection to people being exposed to a disease with other diseases they may have been exposed to, and permits visualizing these probabilities and relationships.

The method may also utilize various privacy tools to protect the private information obtained and stored by the system and to comply with regulatory requirements. For example, personal accounts could be recognized only by system identification number, and other personally identifiable information, such as address could be shared only following an approval by the consumer.

The invention enhances the accuracy, speed and cost effectiveness of diagnosing diseases and detecting environmental abnormalities. This is crucial in particular in situations where infectious diseases and chemical, biological or nuclear weapons are prevalent. The utilization of multiple source driven information that is routinely captured and analyzed, the utilization of a multiple of data information connected to the same location, and the ability to continuously refine and calibrate the system and generate real-time reporting and alerts, provides an essential advantage over fixed diagnostic tools, and/or over non-networked solutions.

The forecasts produced by the method of the present invention may be reported and stored for future reference and can be reduced to decision called by those authorized to make them. The information may be verified against a diagnostic by medical and environmental experts, and the comparison of the results may be entered to the system, to further enhance the system's accuracy. Similarly, future information regarding patients' health and the other collected information may be stored and compared to the model forecasts.

The method may, alone or be used in concert with other interfaced resources, provide for execution and implementation of the decisions made based on the use of the method such as, for example, by providing interactive monitoring and management tools of medical inventory, vaccine management solutions, population move monitoring and geographical data.

One embodiment of the invention is in the recommendation of a drug regimen to infected people. This is important in particular in the context of infectious diseases such as HIV/AIDS, where the nature of the disease and its manifestations with the patient are altering as a result of the drug regimen and compliance level.

Another embodiment of the invention is the recommendation of drug sequencing and drug regimen based on the medical and other information about a patient. In addition to the drug recommendations, the method could also make alerts about risks of using particular drug regimen.

The focus of the present invention is the creation of an information aggregation, storage and processing methodology for processing patient information utilizing probabilities for deriving the illness probability of a person to an infectious disease and/or for predicting a risk of adverse events to one or more drugs. The current invention further deals with infectious diseases such as AIDS and HIV infection as well as other infectious disease treatment recommendations and in particular on drug recommendations in the context of drug resistance.

The Importance of HIV/AIDS Disease Management

There are over 40,000,000 people infected with HIV worldwide, most of which are in developing countries. 5,000,000 new people are infected every year. Over the years 57,000,000 people contracted the disease.

The Human immunodeficiency virus (HIV), is a retrovirus of the lentivirus family that causes AIDS. Retroviruses are unable to replicate outside of living host cells because they contain only RNA and do not contain DNA. The variant of HIV that is the cause for almost all infections is known as HIV-1.

The result of HIV infection is a destruction of the immune system, by way of killing the CD4 T lymphocyte, or T cell. These T cells are an important part of the immune system. As the T Cells die off, the body becomes more vulnerable to other germs and cancers-driven diseases, called opportunistic infections (OIs for short) and neoplastic complications.

When people with HIV get these infections—or when their CD4 T-cell levels get too low—they have AIDS. AIDS is short for Acquired Immune Deficiency Syndrome. Since the epidemic began in the late '80s, more than 20 million people have died of AIDS

Usually it takes many years for HIV to weaken the body's immune system to the point of AIDS. Anti-HIV drugs help prevent this. Even when a person already has AIDS, the drugs can help a person get better. Anti-HIV drugs let many people with HIV infection live healthy lives. Combinations of these powerful medicines are effective in slowing the HIV progress, but they often have serious side effects, such as vomiting, diarrhea, and fatigue. And people with HIV have to keep taking these drugs every day for the rest of their lives.

Historically, individuals infected with HIV were all but lost causes and the healthcare industry could not do much to help prolong their lives or even increase their quality of life. But because of recent scientific advances, not only can the disease be managed, but in the developed world HIV has become more of a chronic condition. Management of HIV disease of course starts with diagnosis. When HIV enters the body, the immune system produces antibodies to fight off the infection. These antibodies are ineffective in destroying HIV, but their presence is used to confirm HIV infection (that is, HIV tests look for the presence of HIV antibodies; they do not test for the virus itself). The tests can use blood, urine or other body fluids.

Following diagnosis of a patient has been diagnosed as infected with HIV, the patient will start receiving anti-retrovirus medication. As part of the tracking of the effectiveness of the anti-retrovirus drugs, clinicians will begin periodic checks of the patient's blood for levels of CD4/CD8 cells and the viral load (the concentration of HIV viral particles in a patient's blood). These tests are used to monitor the status of HIV disease, to guide recommendations for therapy, and to predict the future course of HIV. The treatment of HIV is further complicated by the fact the HIV disease mutates as a response to ARV treatment, and hence the drug cocktails may need to be altered during the treatment.

In addition, before therapy begins, genotyping is now being recommended as it helps guide therapy and decrease the probability of drug resistance.

In the developing world, it is estimated that 90% of people with HIV are unaware of their infection. Expanding opportunities for voluntary HIV testing will be critical to expanding access to both prevention and therapy, yet only 12% of people who need access to testing and counseling services have it. Furthermore, the high cost of the anti-retrovirus drugs and continuous testing has kept the level of treatment of those diagnosed at a very low rate. The World Health Organization's “three by five” initiative, with the target to provide drugs to three million patients by December 2005. To date (July, 2004) the medicines are reaching around 440,000 patients. Prevention and education efforts are aimed toward both infected and healthy population, with disease management efforts aimed at the infected, whose life is prolonged using therapy. A key problem that arose in recent years, is that patients whose life were prolonged but who were not properly educated about the risks associated with HIV, engaged in relationships that in effect increased overall infection rates (that is, living longer, these patients had more interactions with healthy people who as a results got infected). A key recommendation of the authorities dealing with HIV, therefore, is that prevention be integrated with treatment, and that both are followed with education.

Information management systems are often neglected within the context of healthcare delivery. However, in the context of an HIV/AIDS diseases management program an information and communication management system is a vital necessity that must be given special attention both in the initial stages of planning and throughout the implementation and development of the program. This goes beyond the usual parameters of traditional health management information systems, because of the special nature and context of ARV treatment programs, especially regarding the following issues:
new and often expensive medicines and technologies, requiring specific human resources, skills, facilities and finances;
a paramount need to ensure no interruptions in treatment for each patient and active monitoring throughout treatment;
the need for rapid introduction and scaling up of treatment delivery;
uncertainties and lack of detailed experience of planning and implementing ARV treatment programs within public health contexts in limited-resource settings; and
the need for sharing information among different stakeholders so that responses to changing needs within or outside the program can be rapid and effective.
To determine the need for choosing of the most optimal treatment for specific patient, given the response of his or her immune system to a particular treatment.
   The Importance of Better Syndromic Surveillance

‘The minimal means needed to carry out an unconventional terror attack makes it impossible to accurately predict the extent, location, and time of such an assault’ (“Biotechnology: Impact on Biological Warfare and Biodefense” PETRO et al. Biosecurity And Bioterrorism: Biodefense Strategy, Practice, And Science Volume 1, Number 3, 2003).

However, the possibility of biological, chemical or nuclear terrorism should not be ignored—especially in light of world events during the past 10 years such as the Sarin gas attack in the Tokyo subway, the Anthrax envelopes in Washington D.C. and the discovery of military bio-weapons programs in Iraq and the former Soviet Union, and bearing in mind the continuing threat from organizations such as Al Qaeda and allied terror groups.

Non-conventional attacks, because of their nature, are hard to detect early on. An act of biological or chemical terrorism might range from dissemination of aerosolized anthrax spores to food product contamination. Moreover, a covert release of biological, chemical or nuclear agents, alone or in combination, may not have an immediate emergency medical impact because: 1) there may be a delay between exposure and the onset of illness, and; 2) outbreaks linked with intentional releases of biologic agents may closely resemble naturally occurring outbreaks of more common pathogens, such as influenza or salmonella infection. The public health infrastructure must be equipped to respond quickly and correctly to minimize the death, illness and injury that would result from covert biological, chemical or nuclear attacks.

Important indications of intentional release of biologic agents include: 1) an unusual time-dependent or geographical clustering of illness (e.g., persons who attended the same public event or gathering) or multiple patients with clinical signs and symptoms that suggest an infectious disease outbreak; 2) an atypical age distribution for otherwise common diseases (e.g., an increase in what appears to be chickenpox—among adults, which might be smallpox or monkeypox), and; 3) a large number of cases of acute syndromes, or even deaths, suggesting the release of a pathogen.

As with emerging infectious diseases early detection (such as HIV or SARS) and control of biological, chemical or nuclear attacks depends on a strong and flexible public health system at the local, state, and country levels. A networked platform of medical devices to be used continuously is essential, as it allows for connection to surveillance tools and real time data feeds. Should an attack or outbreak occur, surveillance will be needed to identify the presence of the pathogen or the initial indicators of disease as soon as possible so that an appropriate response can be rapidly implemented, along with monitoring and management procedures. The time-frame of detection and response is crucial—a delay in the identification or the misidentification of an attack or its source could cost millions of lives. A coordinated detection-analysis-response cycle would make all the difference between a controlled event and a catastrophe.

A rapid analysis of diseases outbreak and the development of health-threatening conditions is essential. For example, biological Warfare is an area where special and advanced diagnostics is required. The Department of Defense (DOD) reports (http://www.darpa.mil/dso/thrust/bwd/mc_{—}2.htm) that an attack with a biological agent may occur without warning, and that the first indication that an attack has occurred may be the appearance of sick patients, often with the same initial symptoms of a routine disease, such as flu, which is known to cause initial symptoms not unlike anthrax. Immediate diagnosis, is essential for effective response.

Examining multiple sources of information per patient, per geographical area and per facility could be essential for distinguishing between biological agents and common flu or other common illnesses. For example, chest X-rays or CT showed that all patients with inhalational anthrax have some abnormality, although for some patients, the abnormality was subtle. Also, analyzing information from multiple sources could assist in the detection of abnormalities, as it is known to those skilled in the art. Syndromic surveillance systems assist in the early detection of signs of bio-terror attack, or for the spread of other outbreaks. For example, the U.S. Department of Defense Global Emerging Infections System (DoD-GEIS) has developed the Electronic Surveillance System for the Early Notification of Community-based Epidemics (ESSENCE) to enable outbreak alerting using syndromic surveillance. This system monitors military primary care and emergency clinics. The ESSENCE 11 system extends this capability for both military and civilian populations in the National Capital Region. This extension adds more health care data sources along with a variety of nontraditional sources, including daily records of pharmacy sales, school absenteeism, and animal health.

The described invention which includes the addition of input that is based on the periodic results and monitoring of patients, including routine glucose monitoring, temperature measurements and EKG levels of consumers capturing these data is essential for the improvement of such systems, both from absolute perspective, as well as from a cost perspective.

The potential addition to the accuracy of the syndromic surveillance tools is enormous, for example, in the management of the spread and management of infectious disease such as HIV.

Similarly to glucose monitors, other medical devices used on a routine basis by consumers, such as EKG monitors, and spirometers could be connected to personal computers, and hence to the internet, and could provide immediate information to consumers, their healthcare givers and to a syndromic surveillance systems.

The Importance of Data Management of Emergency Situations

The unfortunate event of the last years had also shown the difficulties to confront and manage triage situations caused by large scale terror attacks. This is even more so when the attacks occurs in heavily populated urban areas. The collection of preliminary information right after the occurrence of an attack is critical to asses the number of casualties, the damages and the risk faced by rescue forces. However the struck areas usually become hardly accessible as a result of debris, fires and damaged structures. Sensors, in the vicinity of a struck area my provide valuable information as to the nature of the attack and medical facilities receiving the first injured people to be evacuated from the scene of the event may provide valuable information needed to carry and manage the rescue efforts. Later on, if the attack is of the kind that requires follow up measures such as vaccination, medical check ups etc. the system may mange those procedures too. By providing such a comprehensive solution the method and system can be a powerful tool to handle the threats of the new era that the world has witnessed in recent years.

Policy and decision makers in various areas of the world have concentrated their attention to these difficulties and allocated resources to address the potential risk of possible future attacks. For example, The Cities Readiness Initiative (CRI) is a pilot US program designed to aid cities in increasing their capacity to deliver medicines and medical supplies during a large-scale public health emergency.

### SUMMARY OF THE INVENTION

The method of the present invention for deriving illness probability of any selected person from a database of people stored in a computer and/or on a computer network, comprises: —collecting relational data from every person in the database, said relational data including whether a person has a contact relationship with another person in said database; utilizing a database of illnesses infection probability functions given different illnesses and states of nature including data relating to social relationship; type of disease; probability function of infection given a time unit; length of contact of the particular contact relationship link; calculating at least one relational path between said person and each person in the data base with whom there is a contact relationship, direct or via other persons in the said database; deriving the illness probability of the said person for each of the above relational paths by calculating the probability of the said person being infected with illness by multiplying the illness probabilities of the said person with the probability functions of the persons along the said relationship path; and selecting the path with the highest infection probability from at least one relational paths with the highest probability calculated.

The method of the present invention also permits selecting the optimum treatment for an HIV condition in a human patient from a database describing the treatment profile including efficacy and toxicity of at least one combination of anti-retroviral drugs used for the treatment of patients with different HIV conditions; identifying patient's current resistance profile using at least one of patient medical conditions; comparing the patients current resistance profile with the database and ranking potential treatments according to the patient current resistance profile and providing a recommendation as to which drug or drugs are deemed optimum for treating the patient.

The method of the present invention also permits generating alerts for the detection of emergency events such as the outbreak of an infectious disease or a biological, chemical or nuclear attack and for diseases management, comprising the steps of: collecting data from a plurality of sources selected from the group consisting of: consumers, patients, medical sensors, medical institutions and governmental agencies with the data being collected from a computer interface, telephone, internet, directly from sensor, or from existing databases, and with the data including at least one source of information that is collected from a patient; an information sharing repository whereby medical and other records are being so collected and uploaded to an electronically accessible location; measuring and comparing actual incidence level of a particular event to its normal level and generating an alert when an emergency event corresponding to the detection of a deviation from normal level by a defined amount.

The method of the present invention also permits a given patient to compare his or her medical record with summary information of patients with similar defined criteria comprising the steps of: inputting a set of medical and other inputs from a plurality of other patients pertaining to the medical status of the given patient; entering filter information for the viewing of such other patients with similar information, such as zip code and primary disease; providing said given patient with summary information of other patient(s) with similar medical criteria; reporting to said patient statistical information including deviation from median of information related to said patients primary disease in the requested population, and the corresponding parameter in the said patients medical record.

### BRIEF DESCRIPTION OF THE DRAWINGS

A better understanding of the present invention can be obtained from the following detailed description of the preferred embodiments of the invention when read in conjunction with the following drawings of which:

FIG. 1—is a system block diagram of the present invention;

FIG. 2—is an illustration of an application of the invention relative to clinical preparedness and response;

FIG. 3—is an illustrative of the process of the present invention for people suspected of being infected with SARS;

FIG. 4—is a flow diagram of the present invention for deriving probability of illness;

FIG. 5—is a graphic illustration of illness probabilities utilizing social networking;

FIG. 6—is a disease management functional diagram in accordance with the present invention;

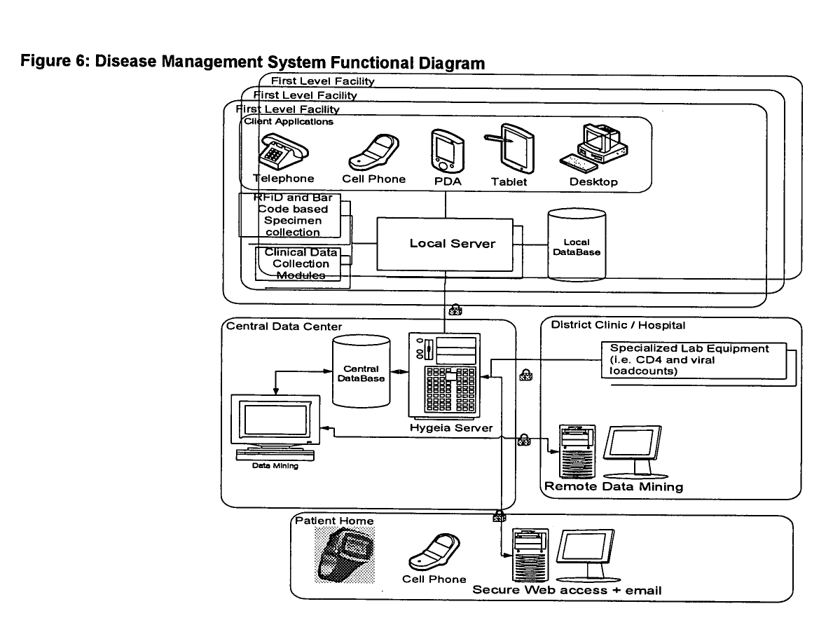

FIG. 7—is an illustrative viral load graph;

FIG. 8A: is a schematic flow diagram of a drug sequencing recommendation in accordance with the present invention;

FIG. 8B: is a schematic flow diagram of a drug treatment recommendation in accordance with the present invention;

FIG. 8C—is an illustrative CD4 Count graph;

FIG. 9: is an illustration of a page view in accordance with the present invention;

FIG. 10—is a general screen flow diagram;

FIG. 11—is a document subsystem context diagram;

FIG. 12—is a custom client solution; and

FIG. 13—is a sharepoint-based solution.

### DESCRIPTION OF THE PREFERRED EMBODIMENTS OF THE INVENTION

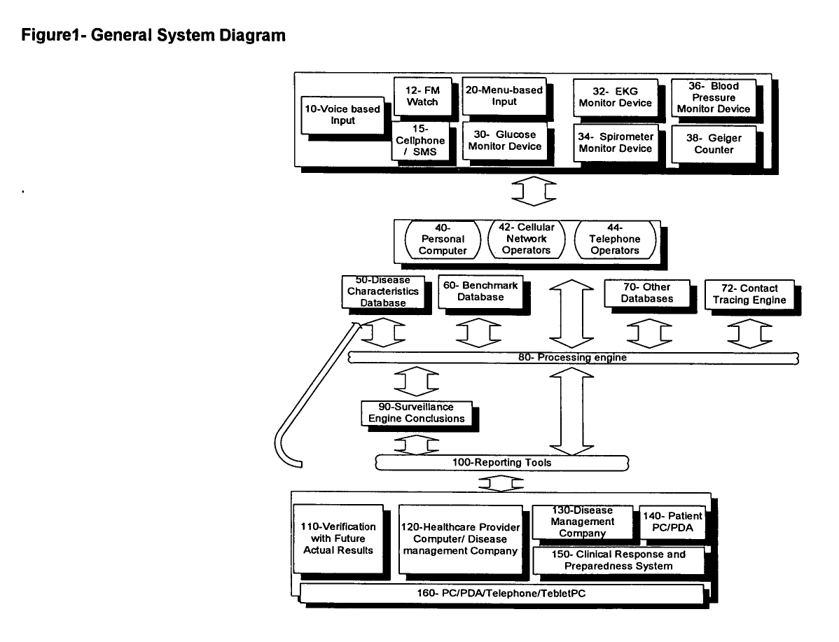

FIG. 1 is a system block diagram of the described system according to one exemplary embodiment of the invention which may be implemented by hardware specifically designated to implement the present invention or by using infrastructure that already exists. As an example, the connection between the locations of the information entry might be connected to the data center through methods such as Internet connections, closed circuit connections, or direct lines.

The computer system for data entry might utilize specially designed medical devices or computers, or existing technologies, such as the described mobile glucose monitoring system. The inputs on components 10, 20 and 30 could be made via many different information entry computer systems. Moreover, the inputs could be transmitted on line or stored locally and synchronize with the rest of the system at certain times when connection is available without departing from the invention.

The information entry computer system, as well as the central computer includes a central processing unit (CPU) for performing processing functions. The computer system also includes a Read Only Memory (ROM) and a Random Access Memory (RAM). The ROM stores at least some of the program instructions that are to be executed by the CPU, and the RAM provides for temporary storage of data. Clock provides a clock signal required by the CPU.

Input to the system could be based on voice driven input (such as the one known to those skilled in the art as Tell Me Service, which allows for questioners to be answered via the phone (see item 10 in FIG. 1). Information may be entered via a computer as described above, or any computer-kiosk such as those present in airport terminals. Input could be menu-driven (see item 20 in FIG. 1).

Other relevant information could be entered to the system; for example, patient specific medical history results from other databases or devices that may have relevance. For example, past blood or glucose level results. Current information could be added directly to the system, via the intermediation of a computer (item 40), cellular network (item 42), telephone operators (item 44) or a combination thereof. Other means of connecting to other data bases and services could be used as well.

Such current medical information could be obtained from medical devices such as glucose monitors (item 30), EKG monitors (item 32), spirometer monitors (item 34) and blood pressure monitors (item 36). Other medical devices and laboratory equipment could be used for such entry and could improve the performance of the system.

Additional information, such as the results of sensors, for example, Geiger counters (item 38) connected to a computer could be utilized to further enhance the quality of the results.

This described embodiment implements a connection via a personal computer or a cellular network to communicate with devices outside the information entry-computer system; however, other methods of communicating with external devices may be used without departing from the spirit of the invention, including, but not limited to, optical communications.

The term CPU, as generally used herein, refers to any logic processing unit, such as on or more microprocessors, application-specific integrated circuits (ASIC), controllers and the like. While the CPU is described as separated from other components such as the ROM, some or all of these components may be monolithically integrated onto a single chip.

Any number of information entry computer systems could be connected to the central computer system. The entry computer system includes a CPU, ROM, RAM, and a clock. The computer system also includes an input/output (I/O) device to communicate with the patient and the medical provider. A wide variety of I/O devices can be implemented for this task, including, but not limited to, a touch screen, a keyboard and a mouse. The I/O device may be linked to the CPU directly or via an intermediate connection, such as an infra-red transmitter and receiver.

While the above description distinguishes between the data sources, they might be entered via the same input computer, for example, by a Pocket PC with a glucose monitor connected to it.

The information entered via the multiple sources may be transmitted to a processing computer system for analysis (illustrated by item 80 on diagram 1), or is being analyzed by a software program located on z local computer system.

The processing engine (80) and the additional databases (items 50, 60 and 70) may use a document management system that utilizes XML format to store, process and display information in a form format. Such document management system makes use of clean XML (that is without any metadata) format on the data base while manipulations of the data which is done by the variety of software tools available is being done on a copy. Prior to re-storing the form containing the processed information all the metadata associated with the form is being separated from the form and saved separately from the form and is indexed and associated with the particular form. This document system provides for modularity, versatility, scalability and enhanced functionality of the invention as many applications and interfaces may be used to process and display the information stored.

The information could be transmitted over any potential network, such as the internet to the central computer. Any suitable communication link which permits electronic communications may be used, including cellular network, wide area networks, satellite and radio links. The transmission may also refer to any suitable communication system for sending messages between remote locations, directly or via a third party communication provider.

The information transmitted may then be analyzed by software. The main mechanisms of analysis may include 1) a comparison of the information, with a database of known characteristics of the analyzed disease or environmental factor. Such database may include information of other patients, a well as historical information of the patient, if the analysis is for a specific consumer, or utilizing statistics about normal levels and changes of results, based on various benchmarks, for example, the geographical area and the age group; 2) The application of mathematical algorithms to infer statistic probabilities and deviations.

In addition to the utilization of commonly used manual medical methodologies, mechanisms of comparing the multi-dimensional information obtained from the various sources into a common database of benchmark have been utilized for other purposes, and these methodologies could be used for the analysis. These items are illustrated in FIG. 1 as a disease characteristic data base (item 50), a benchmark database (item 60), which are used for the analysis (illustrated as item 80). Other databases, storing information from other sources (item 70 in the diagram) could be utilized in order to enhance the quality of analysis, or example, mapping and geographical information relating the identity of consumers to their neighborhood and to other consumers in that area.

Methods such as Principal Components Analysis could be used for the comparison of consumer specific information, or of a group of consumers' information sent to the central computer. Principal Components Analysis (PCA) is an ordination technique which involves an eigenanalysis of the correlation matrix or the covariance matrix. PCA is available in most statistical packages, and is often considered a form of “factor analysis”. Its main applications are: (1) to reduce the number of variables and (2) to detect structure in the relationships between variables in order to classify variables. The applications of principal component analysis are known to those skilled in the art and could be applied in the context of medical signals and indicators. Other methods, known to those skilled in the art, could also be utilized. Such methods include for example neural networks.

The methodologies of such systems may vary, and various mathematical modeling have been used. For example analysts from DoD-GEIS have implemented spatial-temporal anomaly detection methods to detect localized outbreaks and purely temporal methods for the low-level, scattered threat. The usefulness of these algorithms requires both high sensitivity and low false alarm rates.

The data input is used to detect the normal base of patterns of the inputs. These models allow for the detection of suspicious levels of any combination of the signals. Such systems can utilize Data visualization geo-spatial analysis (GIS) tools, such as ArcView. Cases can be plotted by patient home zip code. GIS capability help determine if a syndrome outbreak includes a geographic component and may aid in locating the source of the disease outbreak if it is from a geographic point source. GIS may also help aid in predicting the extent of the affected population to better allocate response resources.

Additional sources of information may be utilized, without departing from the spirit of the invention, such as information regarding prescription filled, and absenteeism from school and work data. Modeling can be used to both verify outpatient diagnostic data and to independently track fluctuations in drug usage that could provide early alerting for disease outbreaks. The information sources described above, and the unique way of connecting multiple manufacturing sources to a coherent platform could create a diverse population of information sources, from which (along with additional information) one could infer about the occurrence of a nuclear, biological or chemical attack.

Following an analysis of the patient specific input with the database, utilizing the algorithms, an output may be a probability, or other indication representing the deviation of a result from a normal situation. The conclusion engine (item 90), could, by using various data mining techniques infer regarding the results of a specific consumer, or regarding a situation in a geographical location or at a time, based on larger populations.

The reporting of the results may be done by using one or more of several potential reporting tools, illustrated by item 100. For example, standard Crystal report, known to those skilled in the art, can be printed from a data base storing the results. An email tool such as Microsoft Outlook can be used to send an email to the patient computer (illustrated by item 140 on FIG. 1), or a related healthcare provider computer (illustrated by item 120 on FIG. 1). Alternatively, the results with the inferences could be sent to a disease management company like the one in item 130 that could refer the information to the proper healthcare provider, or may merely store the information.

The information obtained from the information sources could be sent directly to the above parties, or via the reporting tools, without significantly deviating from the nature of the invention. The information could include personally identifiable information, or only de-identified information which could become identifiable following the approval of the consumer. The information so collected and processed may also be transmitted to a system (illustrated by item 150 in FIG. 1) that may generate a reaction plan and manage its performance.

That abovementioned derived probability may be adjusted by additional information provided by the consumer or may be stored in his or her consumer file at the central computer, or at any other facility connected to the processing engine.

The software used for the diagnosis could be enhancing its performance over time, as it incorporates the diagnosis of new consumer information assisting in diagnosis. That information, enhance the detection ability, as predictive results could be compared to actual tests in the field, or by future medical results of the consumer. An illustration of this mechanism is in item 110 on FIG. 1, where the results of the algorithm are being fed back to the processing engine shown as item 80, via which they could also be stored in other databases (item 70).

The description above does not assume a centralized location of the data base. In fact, the system becomes most powerful, when it is utilizing combination architecture of centralized systems embedded in decentralized systems. This hybrid topology is illustrated in the millions of peers in the system used, for example, in KaZaA. Most peers have a centralized relationship to a “supemode,” forwarding all file queries to this server. Supemodes, in turn are clustered in a decentralized network, propagating queries. Internet email also shows this kind of hybrid topology. Mail clients have a centralized relationship with a specific mail server, but mail servers themselves share email in a decentralized fashion. The nature of the data aggregated by the describe system make an architecture which is based on a purely centralized model impractical.

In addition, such P2P system may allow users to transfer data directly from one computer to another, thereby significantly reducing the cost of the system relative to a central server-based system, since the manager of the described platform provides the engine that allows people to share information stored on individual computers or networks. The developer and manager of the system using P2P will not have to house, configure, or care for a database crammed full of files. Such a system also conveniently solves issues pertaining to privacy, as no single data base stores the complete data records, and data sharing rule between the databases could be conducted using authorization tools and key identifying information that may not include personally identifiable information.

It should be understood the processes described here are only exemplary and any suitable permutation of the processes may be used. The foregoing disclosure and description of the invention are illustrative and explanatory thereof and various changes to the size, shape, materials, components, and order may be made without departing from the spirit of the invention.

While the present invention has been described with reference to the disclosed embodiments, it is to be readily apparent to those of ordinary skill in the art that changes and modifications to the form in details may be made without departing from the spirit and scope of the invention.

### Descriptive Embodiment: Utilization of the invention for Bioterrorism Detection and Emergency Management System

The described embodiment of the invention may be used as a comprehensive bioterrorism detection and management system.

In this context the processing engine (80 in FIG. 1) contains a real-time, population based outbreak and disease surveillance software that may combine data from specifically designed sensors for bio-agents (item detection with information routinely collected by, amongst other sources, existing medical devices, de-identified personal health records, geographic information regarding location such as GPS enabled cell phone) and drug sales statistics. In addition, the processing engine 80 runs an Analytical Software that may perform analyses and visualizations and that may use various bio-surveillance algorithms to detect environmental abnormalities and diseases outbreaks, assist in diagnosis and also may include connectivity to a database that contains symptoms lists and a computerized test-book. Following the completion of the processing the results are transmitted to the clinical preparedness and response system (item 150) for clinical response administration and management, with a focus on delivering real-time information to decision makers in a distributed and field environment.

The invention may assist its users in identifying the nature and location of a suspected attack or outbreak. This embodiment may provide advanced templates for data mining and machine learning of various public health scenarios. It may also inherently provide flexibility in adapting these easy-to-use templates to a particular threat.

Furthermore, in this embodiment the system may develop templates for easy and intuitive display of the processed information that may give public health officials and first responders the timeliness and relevant information rendered in a timely manner and at any required location. Real-time reports may be viewed using client applications residing on desktops, laptops, tablet PCs, or even Personal Digital Assistants (PDAs) and smart-phones (item 160).

This medical information, combined with optional simultaneously captured global positioning system (GPS) or other location-based information, will subsequently be transmitted, securely via a variety of appropriate, high capacity, secure communication infrastructures (e.g., landlines, wireless technologies such as GSM/GPRS, 1XRTT or Mobitex) to a central command and control data center (CCC). The transmission could be conducted using the devices' communication ports, with or without the use of communication devices. The transmitted data is aggregated, combined with additional data sources (legacy and other active data systems), and then finally analyzed and benchmarked to historical patterns in the CCC. Alerts and notices regarding abnormal disease or symptom patterns may be generated based on both preset rules, and advanced analytic tools (such as Spatial Statistical Analysis, Neural Networks and Contact Tracing engines. The alerts may be fed back as responses to the individual patients, to their healthcare providers (item 120) (and become part of a disease management program), or to designated public health authorities interested in the aggregated information, especially as it may provide early warnings signals of an NBC attack, an infectious disease outbreak or other abnormality or deviation from the set standards. The responses will be viewed using client applications residing on desktops, laptops, tablet PCs, hand-held computers or even PDAs or smart-phones (item 160).

Using the software (marked as 80 in FIG. 1) information might be securely captured from a large number and diverse existing data-collection systems to a centralized location. These may include hospitals' mainframes, pharmacy databases, medical records from consumer's computers and test results from various medical devices. The captured information may include data from clinical laboratory results, over-the-counter drug sales, or Emergency Room triage systems, patients' records and diagnosis forms, as well as input from diverse sensors located at other medical centers, government agencies and patients' homes.

This embodiment of the invention may be enhanced by the voluntary participation of consumers, leveraging data they capture as part of their daily routine, for example, the blood sugar level of consumers with diabetes, pulmonary data, blood pressure, ECG information, etc.

The described embodiment of the invention may allow the public health officials to define rules for alerts and also to prepare notices and instruction regarding abnormal disease incidences, symptom patterns or treatment usage. In case of an alert which indicates a need to react rapidly, The Processing Engine (80) may then break-down the large amounts of data collected into relevant and useful chunks of information that is passed to the Clinical Preparedness and Response system (150) which may be designed to manage a focused response, ongoing tracking of the responses, that might include additional testing, mass vaccination procedures, quarantine, medication delivery clinical follow-up, etc.

The Clinical Preparedness and Response System (150) may also function in the field, utilizing mobile computers and other devices that can be used either locally or networked together with a control center. The system described in this embodiment may enable the production of a response that is coordinated from a central location without relinquishing the ability to use local information for quick local reaction and decision making.

It should be understood that the processes described here are only exemplary and any suitable permutation of the processes may be used.

The foregoing disclosure and description of the embodiments of the invention are illustrative and explanatory thereof and various changes to the size, shape, materials, components, and order may be made without departing from the spirit of the invention.

While the present invention has been described with reference to the disclosed embodiments, it is to be readily apparent to those of ordinary skill in the art that changes and modifications to the form in details may be made without departing from the spirit and scope of the invention.

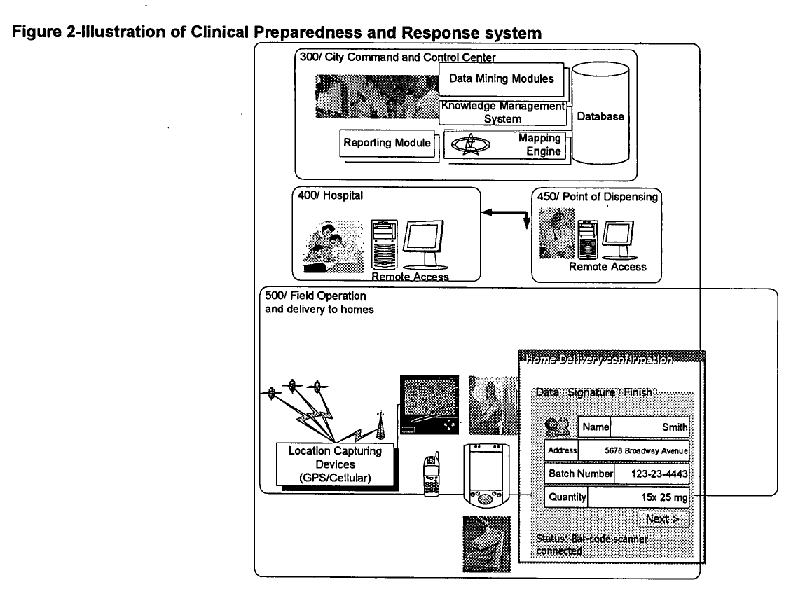

FIG. 2 illustrate in greater detail one embodiment of the Clinical Preparedness and Response system (Item 150 in FIG. 1). FIG. 2 and the explanation hereunder the invention is applied to a representing city as an entity seeking to maintain preparedness and response system. However, the described embodiment is equally applicable to any municipality, agency and other entity.

Information is being gathered at the city command and control center 300, where the central data base, knowledge base and analysis engines reside. Information related to hospitalization and issues such as drug adverse events are reported from the hospital 400. Medication is dispensed at point of delivery 450 where drugs are being distributed to the field employees involved in the drug dispensing. Information related to the progress made in distribution, as well as information related to the identities of the personnel involved in dispensing is captured in these locations, where the drugs are also being stored prior to distribution.

Field personnel 500 captures pertinent information related to the drug dispensing on mobile devices such as PDA with GPS enabled cellphones (otherwise known as GPS enabled smartphones), as well as using bar-code or RFiD readers that reads the information on the drug being dispensed, and capture that information as part of the record of the recipient, which could be an individual or a group such as a family. The mobile units could capture information including signature of the recipients of the medication, as well as demographic information. GPS signal could be used as a vehicle of authentication of drug dispensing, as the signal indicating a location of drug disbursement could be compared with the identity of the individual or groups such as a family. For example, the field worker distributing the drug will capture information including signature of the individual receiving the drug. The name and signature could be compared to the expected home address of the person, given his or her address on the vital records or any other publicly available record of the address.

Utilization of the Invention for Early Detection of Disease Outbreaks

The invention and the illustrated embodiment of the invention are highly effective for early detection of disease outbreaks such as SARS. For this purpose individuals or organizations securely submit medical information by either: 1) direct collection and distribution of data from existing medical devices, such as thermometers, glucose monitors, blood pressure devices, or ECG monitors, which are being used by the relevant healthcare providers (items 10, 30, 32, 34 and 36 in FIG. 1), or; 2) collection through input devices, such as Internet-enabled PCs, hand-held computers, telephones, mobile phones, or two-way pagers (item 20 in FIG. 1).

This medical information, combined with optional simultaneously captured global positioning system (GPS) or other location-based information, will subsequently be transmitted, securely via a variety of appropriate, high capacity, secure communication infrastructures (e.g., landlines, wireless technologies such as GSM/GPRS, 1XRTT or Mobitex) to a central Command and Control Center (CCC) that hosts the processing engine (80). The transmission could be conducted using the devices' communication ports, with or without the use of communication devices. The transmitted data is aggregated, combined with additional data sources 70, and then finally analyzed and benchmarked (by item 60) to historical patterns in the CCC. Alerts and notices regarding abnormal disease or symptom patterns are generated based on the processing engine's (item 80) settings, and advanced analytic tools (such as Spatial Statistical Analysis, Neural Networks and Contact Tracing engines).

The alerts may be fed back as responses to the individual patients 170, to their healthcare providers 120 (as part of a disease management program), or to designated public health authorities interested in the aggregated information (item 180), especially as it may provide early warnings signals of an NBC attack or an infectious disease outbreak. The responses will be viewed using client applications residing on desktops, laptops, tablet PCs, hand-held computers or even PDAs or smart-phones.

Numerous tools could be implemented to protect the privacy of users' information in compliance with privacy regulations (e.g., HIPAA). For example, personal accounts could be recognized only by system identification numbers; other personally identifiable information, such as address information could be shared only following an approval by the patient. Healthcare providers, government officials and other could look at aggregated and summarized information and/or at patient specific information (taking account of privacy and information security). In addition, individuals could have access to their own medical records, and could compare their physical results with those individuals with a variety of similarity levels to them. For example, a person who is 55 years old and who has diabetes and who measures his glucose level once a day. Assume the person participates in the detection system described above. The individual would be able to compare the glucose levels to the averages of groups such as: “the entire population”; “entire population of people at the age of 55”; “the population with diabetes” or “the population of people with diabetes in age group 55-65”.

Access to such reports could be via data communication vehicle such as the internet, by obtaining a login and password from the authority responsible for maintaining the database, and accessing the personal medical records viewable on the computer screen.

The reports could be calculated and prepared by standard analysis and reporting tools such as Microsoft Excel, SAS and SPSS, and reporting tools such as Crystal Reports and their preparation is known to those who are skilled in the art.

As mentioned above, the invented method and system may readily be used for a variety of applications related to screening, diagnosis and treatment of diseases. An example of such use follows:

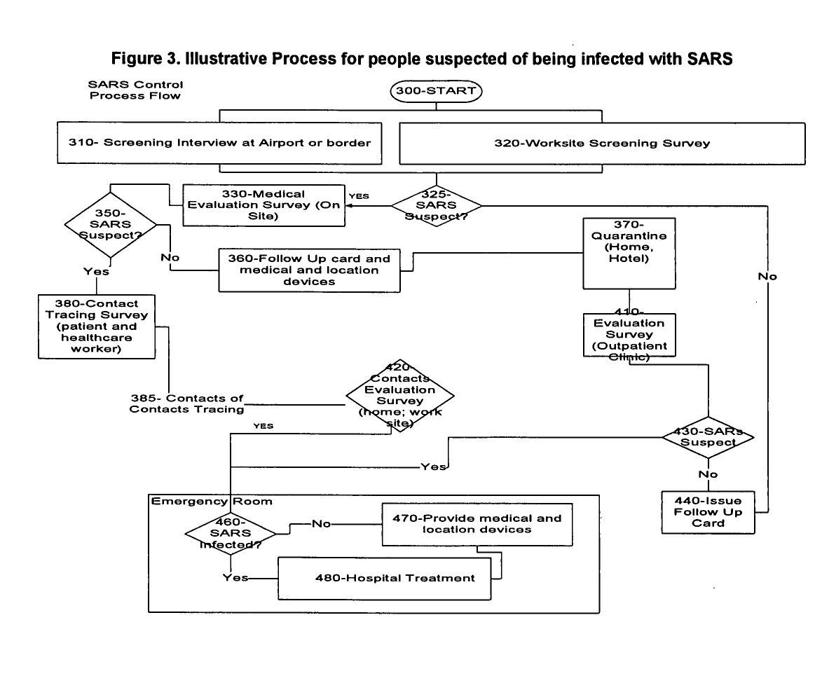

For example, FIG. 3 illustrates the screening, diagnosis and treatment of SARS suspects using the invention. The process begins (item 300 in FIG. 3) with a questionnaire being provided to people at select locations (for example, all travelers from countries where SARS cases were found will be interviewed at the airport or border—310 in FIG. 3—, or at work sites—320 in FIG. 3). The survey (which may include automated temperature checking) will be input to a tablet PC or a Wi-Fi enabled PDA, and will be transmitted via the internet to the CCC (Command and Control Center). If any of the symptoms-related questions (which could be medical or other) is answered with “Yes,” the traveler is deemed as a SARS suspect (item 325 in Figure) 3 and is forwarded to medical evaluation (330), which will typically be done at the same location. A medical evaluation survey will be filled and transmitted over the web via a tablet PC or a Wi-Fi-enabled PDA to the Command and Control Center (CCC). If the person is not suspect, s/he will be issued with a follow up card with instructions (such as what to do if certain symptoms appear)—item 440 in FIG. 3.

If the traveler is cleared (that is, has no SARS) as demonstrated by item 360 in FIG. 3, he or she will receive an information card that includes information if additional symptoms appear. In addition, the person could be requested to be quarantined for up to 10 days (the typical SARS incubation period)—Item 370 in FIG. 3). By way of example, during the quarantine period (typically 10 days) the person could be requested to fill up a daily web report (which may include temperature taken via a digital thermometer), and a location-aware device might be attached to him/her (such as a GPS two-way tag), to ensure compliance. At the end of the period, the person will have to visit a doctor (at the hospital outpatient clinic) for further medical evaluation, before he or she is cleared.

Quarantine: The policy of quarantine could be set based on the results of medical evaluation, or based on other parameters. For example, to support a SARS surveillance system like that instituted in Taiwan on Apr. 28, 2003, all arriving passengers from SARS affected areas, regardless of the nationality of the passenger and including those originating from non-SARS affected areas but who have made transit stops at SARS affected areas, must comply with a compulsory 10-day quarantine. Foreigners would be required to complete their 10-day quarantine only at a designated hotel near the international airport. Following or during the quarantine period, evaluation will be conducted (410 and 430 in FIG. 3). IF the person does not have the pre-defined symptoms, s/he will be released. If s/eh does, s/he will be sent to ER (460), and if not, will obtain a follow up card (item 440 in FIG. 3).

A contact tracing survey (380 in FIG. 3) will be completed (over the web, and entered using a tablet PC or Wi-Fi-enabled PDA) with all of the relevant contacts made in the last 10 days. Healthcare workers (of the department of health or the hospital) will go to the contacts home (or worksites) to investigate them (and fill out the reports on the web or on PDAs)—385 in FIG. 3, and will derive some conclusions (420) using such decision making process as described in this invention, which will assist in the decision if the person is suspect of SARS. If the person is a suspect of SARS, then s/he will be sent to the emergency room (460) to be examined if s/he is infected with SARS.

A person who is classified as a suspect by the medical evaluation (420 or 430), will be referred to the Emergency Room (ER) or ER-managed triage site (460 in FIG. 3), where further investigation and treatment will be provided under appropriate precautions for infection control and isolation (470 and 480 in FIG. 3).

As an alternative, a computer might contact them by phone and ask them to arrive to the Emergency Room or to an outpatient clinic for examination, or fill up a screening survey over the phone, using an automated voice entry (IVR) system. Contacts who are suspects will also be investigated regarding their contacts in the last 10 days. These contacts of contacts will be examined in a similar fashion. The contact tracing engine will refine the probabilities of whether a particular patient is infected with SARS according to the parameters, such as the nature of the contact (i.e. spouse, co-worker) and length of contact, and patients above a threshold probability will be investigated further.

Following the ER process, patients are: 1) hospitalized and referred to a special ward; 2) be released to their home, or; 3) released to their home and quarantined. Patents who are hospitalized are treated by the Hospital and by the end of the treatment are discharged and quarantined for additional 10 days (such as the process in item 370 in FIG. 3).

All the information will be aggregated at the CCC and referenced with additional information obtained from the hospital and other sources (such as the Districts Department of Health). Such information will be utilized to initiate the investigation of additional population groups, using a similar data flow as described above. For example, following an alert of an increased number of patients who arrive to the ER with SARS-related symptoms from a particular ZIP Code, an investigation might be initiated to locate the contacts of these patients.

The hospital-based alerts, as well as alerts based on other sources, could be managed at the CCC or at external databases, depending on the location of the data. The alerts could be based on spatial analysis or automatic query-based thresholds such as “number of flu complaints >125% of the average in the past 90 days”, or based on pre-specified probability levels, (e.g., “flu complaints exceeds the moving average of the past 90 days by 2 Standard deviations of the moving average of flu complaints”). This is important because of the potential for misdiagnosis, such as SARS masquerading as influenza. Alert levels could also be set based on multiple data fields. Such multi-parameter alerts could be based on deviations from historical patterns as analyzed by an inference system of the system.

Such inference mechanism could be as simple as one including the number of cases of flu complaints in similar periods of previous years, or a dynamic mechanism such as a comparison to the moving average of flu complains for the period preceding the date of complaint. Such calculations are known to those skillful in the art of statistics, and could be based on multi parameters, such as deviations from the results of the forecasted value of complaints given the set of parameters that are typical for that complaint. For example, if the number of complaints of flu for a given date was calculated in the past and is forecasted to be Number of Flu Complaints on a day coming from ZIP code=(12-MONTH)+Temperature in the ZIP code*10%+Average Age of Residents in ZIP code*2%, and assuming the temperature in the ZIP code on that day was 100, with average age of residents of the zip code being 50, and the month was February, the forecasted complaints would be: (12−2)+100*10%+50*2%=10+10+1=21.

Assuming further that the actual flu complaints from the same Zip code were 30, and that the standard deviation of the calculated forecasting function versus actual past results was 3. Therefore, the number of complaints is deviating by three standard deviations (30−3*3) from the expected number of complaints.

If such information is missing, the patient (or patients) will be traced at the hospital, for forms completion. For each contact or contact of a contact of a SARS suspect, a query could be made to the hospital database, to examine whether that person is hospitalized. If this is the case, the referring SARS suspect will be flagged for special immediate clinical review.

At the CCC, data could be reported using “drag and drop” of chosen variables. Data could also be seen on a map, where specific quarantined people with tracking devices could be displayed. Rules for alerts could be defined at the patient level (for example, a patient that is quarantined but leaves his home), or in the aggregate (for example, average temperature of quarantined persons above a specified level, during the last 24 hours in a particular ZIP Code). Such alerts could be utilized to initiate medical investigation of the quarantined individuals.

Furthermore the alerts could be sent even directly to the patient, suggesting a particular action items, such as “PLEASE go back immediately to the ER”, or: you are advised to go to your doctors and check for a change in your prescription”.

Illustration: Estimating illness Probability Using Contact Tracing

The invention includes and may use Contact Tracing mechanism for sickness probability embedded in the processing engine (80 in FIG. 1). This mechanism could be used for estimating and visualizing infectious disease spreading, including infections within hospitals. The basic approach of such contract tracing will be similar to the approaches of social networking, known to those skilled in the art. Such deployments of the approaches are used in other contexts by web sites such as LinkedId. The invention, though, focus on utilizing the basic concept of social networking in the inferences of disease spread and infection probability.

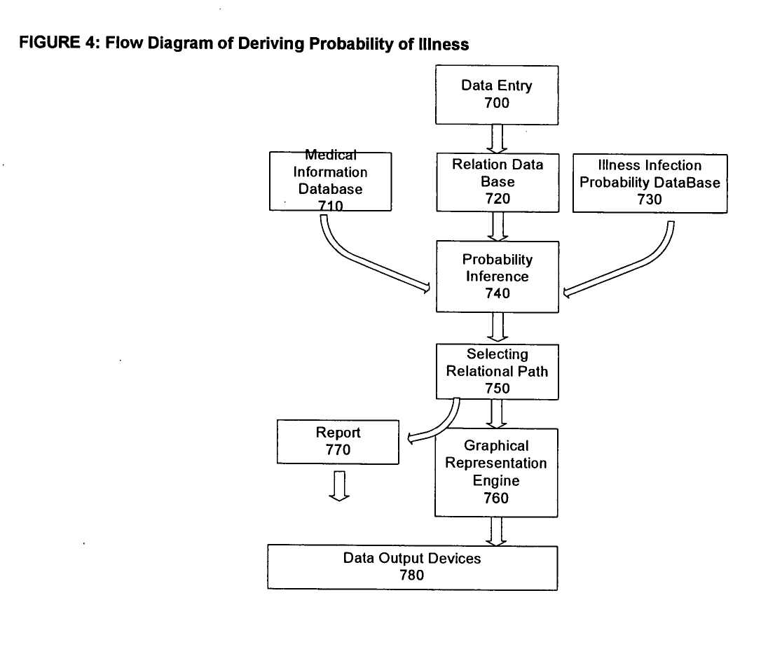

The contact tracing mechanism takes account of medical information pertaining to a person, and his or her relation to other persons (“Contact Relationship”) in the data bases (70). For example, given a set of medical criteria and using the flow diagram in FIG. 4, a patient is determined to have a probability of 90% to have SARS. The computer system in the processing unit 80 considers the relationship between that patient and other patients whose data is stored in the engine 80.

FIG. 4 is a flow diagram of the process of deriving illness probability in accordance with the present invention. Information could be entered to the system (700 in FIG. 4) by using a few parameters that create relationships between personnel (720 in FIG. 4).

In addition, information pertaining to the probability of infection (given a particular disease) for each type of contact could be defined or obtained from other sources (730 in FIG. 4).

Illustrative relations and probabilities are:

type of link
type of disease
probability of infection given a time unit
length of contact of the particular link type

For example, assume relations of husband-wife is defined as link type 1; person-work colleague is link type 2 and a neighbor is link type 3. Link type 1 is defined as probability 100% for SARS, and probability 80% for influenza infection, provided they are in contact for more than a week.

Given additional medical information (710 on FIG. 4), a husband is estimated to have a probability of 90% to have influenza infection.

Hence, the probability for the Husband-Wife relation path 80%*90%=72%. Naturally, more complicated probability functions could be used. For example, one could use a variety of diffusion processes probability functions; normal distribution functions etc. The probability functions could be different for different links and contact distances. Also, the representation of the links could be themselves part of the function. For example, the probability could be Independent Probability=(10−Link)*8%, so for the example above, if a link to one himself is defined as link 0, the probability of the wife having influenza is [(10−0)*8%]*[(10−1)*8%]=80%*72%=57.6%

The illness probability could also be “state dependent” meaning that the probability may be different at different states of nature, such as in different seasons of the year, at different geographical areas and as a result of other factors known to those skilled in the art affecting the chances of infection. For example, the infection probability between husband and wife could be defined as 80% for influenza infection during the months of January-March, and 50% for the other months.

The calculation of the probability could be based on the choice of the path with the highest illness probability given the variety of path between persons in the data base (see 750 in FIG. 4). For example, let us assume that there are 4 people in the contact data base, with connection between a person and his work colleague that could be by direct contacts (assuming these have a derived illness probability of 40%) and also via his wife as she is a good friend of that colleague's wife (assume illness probability via that path of 30%). The path which is the direct contact with colleague is the selected one as it carries higher probability.

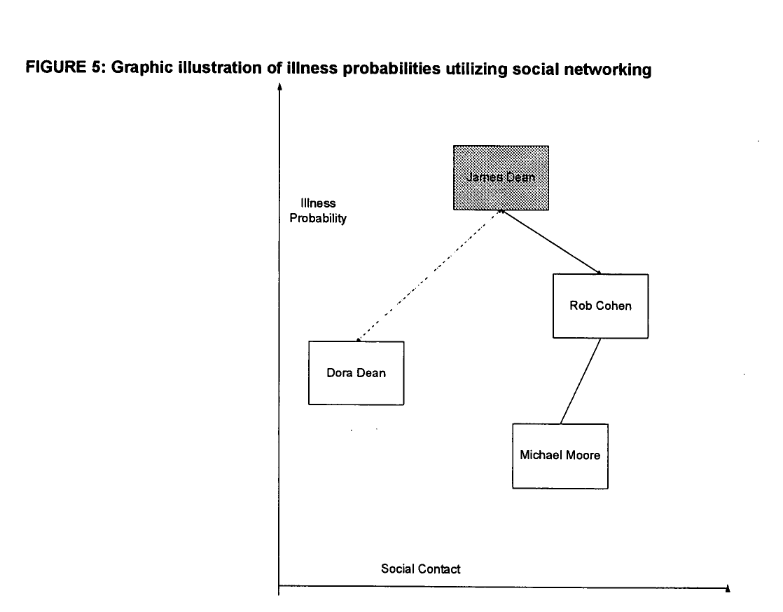

A variety of textual and visual report could be designed in order to describe and visualize the illness probabilities as they relate to people (760 and 770 on FIG. 4). For example, each person in a data base could be defined as the center for an illness probability view. All the people whose information is stored in the database (or a defined subset, and in particular those appearing in the database as infected) are being showed on the screen, with potential lines connecting them. A color or other symbol could signify the link type between the persons. FIG. 5 illustrates such representation where James Dean (in the shaded box) is the focal point. For example, in FIG. 5, Dora Dean and James Dean are connected by a striped line which signifies in the illustration husband-wife relation). FIG. 5 illustrates the probability of infection on the Y axis and represents the persons with direct and indirect links to James Dean. For example, Rob Cohen is directly linked, whereas Michael Moore is indirectly linked. While in the illustration James dean has the highest probability of his social network and also the focal point of the visualization, this may not be the case at all times. For example, had Michael Moore been diagnosed with the disease, he would have been higher on the axis than James Dean, who is the focal point in this illustration. Naturally, many ways of graphically illustrating the results of the method could be envisioned. For example, one could have on the Y axis probability for SARS and on the X axis the probability for HIV.

Use of the Invention for Chronic Disease Management

The Invention is also highly effective in managing the treatment of chronically ill patients such as patients with HIV. The following description elaborates on the disease management of HIV patients using the described embodiment of the invention and leveraging on the modularity and flexibility of the invention.

The described embodiment of the invention present an integrated data management system for managing information related to various infectious diseases and care processes during various disease stages. Particularly, the invention is apt for disease specific deployments, and the preferred embodiment describes the management of the data associated with HIV/AIDS testing and treatment cycle.

The current embodiment allows assessing a patient situation, advising on the course of treatment, and arranging patient and disease related information in an actionable manner that assists the clinicians in deciding the course of action. It supports patient education and self-management while organizing proactive follow-up. It further allows the involvement of remote and local experts during different stages of care, and to link the patient to community-based resources and support. The invention in this embodiment of it may serve as a repository for treatment plans, patient calendars, and treatment cards and may include detailed reports and alerts that ensure the continuity of care, and which are useful for decision support by public health officials. Such decision support is further enhanced by advanced configurable data-mining modules that screen the collected data and look for changes and anomalies that are indicative of changes in the patient's condition. A detailed example(s) of drug sequencing and regime recommendations and/or alerts are provided later in the description.

In its current embodiment the invention is designed to be used by both experts and lay staff in either a fully equipped medical centers or a low resource setting, and to this extent it is self-contained and can work in online and off-line modes. The system is highly modular, and in particular deployments, certain parts may be included or excluded, depending on the infrastructure and available resources. All components are configurable, easy to use and are based on an intuitive user interface, and all the data management processes are user and process centric as also described above.

The System users which include, in this context, patients, medical professionals and government authorities will access the system using personal computer (20 in FIG. 1) or a voice input system (10) or FM watches (12). The patients using the system will feed, by answering preset forms and questionnaires, into the system the medical and other information relevant for their disease such as viral loads, cd4/cd8 cell counts, infections, and other relevant information. In addition information about the users will be collected by the variety of medical devices and laboratory tests (such as items 30, 32 and 34 in FIG. 1). Through the input device 20 patients would also be able to access the system for running diaries of their disease and access available information on the disease.

Based on the information entered into the system the processing engine 80 may run a set of calculations and produce several reports to the users. Such reports may include alerts of disease advancement or recessions, the need for follow up tests, efficacy of medications and recommendation for suitable medication combinations as customary in the treatment of HIV.

The processed information may also be transmitted to the clinical response system (150) that may then produce and manage the recommendation for treatment for all or part of the users. For medical professionals the response will include the online monitoring of medication inventory levels and supplies as well as on-going monitoring of their patients. The reports generated by the clinical response system may recommend drug sequencing for particular patient in order to best control the drug resistance that often occurs with the treatment of HIV.

The invention facilitates the principles of good care. It allows assessing a patient situation, advising on the course of treatment, and arranging patient and disease related information in an actionable manner that assets the clinicians in deciding the course of action. It supports patient education and self-management while organizing proactive follow-up. It further allows the involvement of remote and local experts during different stages of care, and to link the patient to community-based resources and support. The invention serves as a repository for treatment plans, patient calendars, and treatment cards and includes detailed reports and alerts that ensure the continuity of care, and which are useful for decision support by public health officials. Such decision support is further enhanced by advanced configurable data-mining modules that screen the collected data and look for changes and anomalies that are indicative of changes in the patient's condition.

The invention can be used by both experts and lay staff in either a fully equipped medical centers or a low resource setting, and to this extent it is self-contained and can work in online and off-line modes. The system is highly modular, and in particular deployments, certain parts may be included or excluded, depending on the infrastructure and available resources. All of the computer screens of the invention are configurable, easy to use and are based on an intuitive user interface, and all the data management processes are user and process centric.

Below are some types of users that would find the system useful:

First Level Facility Staff and Field Clinicians

Using either mobile devices (tablet computers, PDAs or cell phones), telephones, or desktop computers first level facility staff (lay staff) get immediate access to a paperless patient electronic record. This secure record will include demographic and clinical information, lab results, treatment plan and medication instructions, and serve as an infrastructure for the following activities:
Patient Registration into the system
Triage
TB and pregnancy status check
Assessment of eligibility for anti-retro-viral therapy (ART or ARV) according to pre-populated templates for decision support
Recording of treatment of Opportunistic Infections (OI) and other complications
Adherence plan preparation and support
Management of First-line ART regimens
Clinical monitoring using patient diary
Response to new signs and symptoms on ART and feedback to district clinic
Dispensing of medications
Preventive interventions including drug administration
Follow-up visit arrangement and management

The patient records will be shared with experts at the district clinic/hospital and the first level facility staff will be able to send and receive messages pertaining to a patients treatment.

All Information will be displayed in an actionable manner that includes next steps for care and instructions from supervisors. In addition the system will alert the lay staff on any anomalies in the data collected or reported, thus reducing error rates and accelerating further care if applicable.

District Clinic/Hospital Staff

At the district clinic and/or regional hospital experts can use the system when they treat the more complicated cases, and run lab tests (including CD4/CD8 and viral load counts). The invention allows experts and district clinic staff to:
Develop Treatment Plan for certain patients, including decision support for drug sequencing.

Initiate ART in patients with complications
Supervise clinical teams at first-level facility and ART delivered at first level facility by remotely monitoring patient records
Manage and report severe side effects and toxicity
Follow-up with lab, monitoring when needed
Evaluate and generate reports for treatment failure
Manage severe illness and hospital care as needed, logging all activities in patient diary.

District clinic staff can utilize the invention using desktop or laptop computers. In that context, the system will be connected to the lab equipment using secure communication lines, eliminating the need to type in complicated lab results.

All information will be displayed in an actionable manner allowing the experts to monitor their patients when they are at the hospital or under the aegis of the first line facility in a seamless manner.

A report and alerts module will help monitor adverse events, and evaluate the success of a treatment plan for an individual patient or a whole cohort.

Public Health and Government Officials

Public health official and program managers can utilize the system in order to monitor and evaluate program effectiveness and efficacy.

Using thin client applications residing on desktops or laptops, these users will be able to log in to the central data center and view reports, charts, and maps that summarize the activities of a given plan using a Geographic Information System (GIS). Reports could be individualized down to a single patient level, or give an overview of an entire cohort or program.

Using simple to use templates for data-mining the user will be able to generate reports that measure various aspects of the program in a rapid manner. Using a rule based engine users can be alerted if certain parameters meet or exceed pre-defined threshold, thus allowing immediate response to any developing anomalies.

Sponsors of efforts could track the progress of the treatment, both for campaign effectiveness as well as for budgetary monitoring. Using the systems integrated inventory management capabilities, and recommendation engines, sponsors will know if their programs are progressing according to the plan, and how well the resources are utilized.

Patients Diagnosed with HIV

Patients can use the system in several ways to assist themselves as they learn about the disease, comply with the sometimes complicated medication regime, and communicate with their healthcare providers.

Patients will have access to their related medical records though a secure portal, where they will be able to access a knowledge-base, and report changes in their conditions through the Internet or through a telephone. They will also be able to sign up for alerts that will be delivered, when necessary, via a variety of means including email, SMS, or even personalized messages to wrist watches.

Representing Module Overview

While this invention has been particularly shown and described with references to preferred embodiments thereof, it will be understood by those skilled in the art that various changes in form and details may be made therein without departing from the spirit and scope of the invention as defined by the appended claims. Those skilled in the art will recognize or be able to ascertain using no more than routine experimentation, many equivalents to the specific embodiments of the invention described specifically herein. Such equivalents are intended to be encompassed in the scope of the claims.

The HIV system configuration consists of three main types of modules:
Data collection modules, including
   Form based screens for demographic and clinical data collection in a first level facility/clinic and/or field environment.
   Patient diaries
   Data import from lab and medical devices (including CD4 and viral load counts) in a district clinic or hospital
Medication dispensing and management modules, including
   Medication and medical supplies management tools
   Prescriptions
Data mining and Reporting modules, including
   Patient based progress reports, including alerts for necessary follow up
   based reports for public health decision support
   Mapping based reports and visualization tools
   Alerts for anomalies and change in trends
   Decision supports tools regarding the optimal drug treatment given the disease progress

Different modules of these components will be deployed in one of four settings:
First Level Facility
District Clinic/Hospital
Central Data Center
Facilities of public health program

The following sections describe these modules in detail.

General System Design Principles

Types of Applications

Users can access the system using one (or more) of the following applications:
a thick client installed on laptops, tablets, desktops or PDAs
a thin-client (web only) version that can be accessed from any location with an Internet connection
an interactive voice response (IVR) system
an alerts system through email, SMS, instant messaging or direct FM alerts to watches.

Thick clients will be used primarily for data collection in the first level facilities and during field operations where the availability of a network connection is not guaranteed. Any data collected in such offline mode is securely stored on the mobile device, and later synchronized with the local server, when network connectivity becomes available (by using either a physical connection or broad-band or dial-up internet connection). If applicable, this data will later be synchronized with the central data center.

Thin clients will be used primarily for report generation and program administration and would, naturally, require a stable network connection.

The interactive voice response system will be used where computer access is not available. IVR will enable remote users to access certain system functions remotely using a simple cellular or landline phone, without the use of a computer. IVR will be used primarily to exchange voice messages among clinicians, to report adverse events and to receive alerts.

Alerts can be sent to patients or clinicians in many modes of communication that include email notifications, short text messages to cell phones or pagers, instant messages to appropriate clients, and, where coverage is available, personal alerts to broadcast enabled personal devices like wrist-watches.

In order to streamline the flow of data and the user experience, to the extent possible the different client applications will maintain a consistent user interface, and use the same software modules.

Audit Trail

The system has a full audit trail mechanism, this means that each time a user creates a new record or updates an existing record the application will record the username of the user who performed the action, the date and time of the action and the reason for the change (in case of a change).

Each history item must indicate the time in which it was modified and the user who has modified it. The system also allows users to enter a remark next to every change made to any value to enable reasoning trace.

In each question screen the user can click on the View Audit Trail button that opens a new page that shows the entire record history. In addition if changes done to one or more question after the first entry, the audit trail displays the question text, and below it a list of all the permutations of the answers, where for each one of the permutation it displays the old value, the new value, the user who made the change, the date, time and the reason for the change.

Data Synchronization

The method and system allows for data collection and use at various locales, including in low-resource settings where network connectivity might not be available at all, or might be available intermittently. For this reason, all data that will be collected is initially stored locally using secure means, and later synchronized back to the central data center.

In addition, the system embodied in this description is designed to integrate data from various sources (i.e. patient diaries and lab results) that might be physically present at different sites (i.e. local clinic vis-a-vis regional hospital).

Data Collection

Form Based Screens for Data Collection in a Clinic and/or Field Environment.

The invention is a forms based system. Forms are the main mechanism for data collection in the system. Forms can be accessed using both visual and voice interfaces. Forms are mainly used to gather information from patients, to record the course of treatment and to concentrate the data collected during clinical procedures and from lab tests. Forms are also used for sharing information among clinicians that are located at separate sites.

Illustrative Use Cases

An elaboration of some exemplary use cases may assist in further explaining the invention and some of its uses. These use cases are in no way, however, all the possible use cases made possible by thw invention.

Use case I: Patient comes for screening for the first time, in a field clinic. The patient needs to be registered into the system, undergo triage, and referred to lab exams, and the regional clinic if necessary.

Use case II: patient comes for a recurring, pre-scheduled visit. Clinic staff need to decide if the patient should start ARV therapy.

Use case III: Patient comes to regional clinic. Medical staff needs to retrieve patient record, and view recent history, triage report, and decide on medicine regimen and record it. This clinician needs to see the recent lab results.

Features

Forms are basically a container for Items (which are logically grouped into Item Groups). The Form also encapsulates logic that can be set for the items, such as a specific item value that leads to affecting the appearance of another item.

Items

Each of the form items consists two parts:
A text object
A value definition object.

Administrators can define items and associate those with forms (See below under Items Management).

Items can be either textual or can include multi-media. Item values can have the following types, and allows the flexibility of adding additional types:
Text
Whole Number
Real Number
Date
Time
Date+Time
Boolean
Binary (field can be assigned a generic block of data, such as a file content)
Sound
   Form Views

If Forms can be regarded as the MODEL, then Form Views are the VIEW counterpart. As simple examples, InfoPath is a Form View for XML-based Forms. A browser displaying HTML (possibly using XForms extensions) is also presenting Form Views. But other views are also possible, such as VXML.

In general, in any place where Form data can be represented by XML (a design goal), the Form View will be able to be rendered to using XSL.T

Form Auto-Completion

Form auto-completion refers to the ability of a form to be created (e.g. for a patient's visit) when some of the form's items already have values; the source of such item values is always a matching field that was already filled before (typically for another form). The meaning of matching is the very same item (typically with the same item-id) being reused in two different forms.

The intention of this feature is to save the user from retyping data that was already entered into the system, and because of that this feature should be used carefully, and explicitly authorized for any particular disease protocol.

It should be noted that in some cases, auto-completion can be replaced by redesigning the forms in a way that avoids asking the patient for the same piece of information in two different forms.

Auto-completion can assign an item with a value from:
A matching item from a form that was previously filled for the patient during the same visit (e.g. patient temperature)
A matching item from a form that was previously filled for the patient in any visit, including past ones.
A matching item from the patient's record (e.g. date of birth), or a calculation that is derived from it (e.g. age)
A matching item from the site environment, which is global for patients (as opposed to a per-patient information) (e.g. date, site location, active user, etc.). The system will allow the form designer to confine auto-completion to the desired scope from the above list, for each item in each form individually.

An enhancement to the above is that instead of a matching an exact item the user can choose to auto-complete an item from another item that is referenced by its item-id.

### FORM EXAMPLES

Following are examples of forms that will be used in the system. These forms will come as template forms. Site administrators with the appropriate permissions will be able to change the forms using the administration tools.

Triage Form

Triage Forms can be used during the process of registration of new patients and follow up of registered patients. Triage form includes
Demographic information (If follow-up, auto-completed)
Weight measurement
Determined reason for visit
Interval history from last visit
Recording of new chronic problems.
Check record for TB
Referral to health worker if necessary
   Education and Support Cards

These are special forms that, according to the treatment selected for the patient guide the medical and lay staff in educating the patient, and explaining the course of treatment. Unlike some of the other forms, education forms are pre-set, and are not intended to collect data, but rather to deliver data to the patient. These forms can be printed and handed out to patients to take home with them. Education forms can include
Disclosure of medical condition and course of treatment
Explanations of conditions, course of treatment, and follow-up care
Information regarding adherence to care, prophylaxis, etc
Special support

For example

An ARV treatment education form will include to following informational items:
Good news
   ARV treatment can stop the HIV virus from multiplying.
   You will probably gain weight, start feeling well, and resume your normal activities.
Not so good news
   Not a cure—need to take the ARV drugs for the rest of one's life.
   You still have HIV infection.
   You still can transmit HIV—safer sex and other precautions are still important.
   You must swallow the medicines twice daily (by the clock) and miss no doses. This is important to maintain blood levels.
   If you miss doses, resistance might develop—this is both bad for you and for your community (uses up the treatment options). Even missing 3 doses in a month is too much!
   Requires lifelong clinical and occasional lab tests. We have arranged that this can be done near your home.
   Side effects can occur.
      Visit Forms (e.g., for Treatment and Follow-Ups)

Patient visits have forms for each different procedure, e.g. for different treatments.

Standard visit form includes
Review of medical history (auto complete).
any new symptoms or problems?
Record of any of the following?
   Cough?
   Night sweats?
   Fever?
   STD? signs? (use locally adapted screening question)°
   Diarrhea?
   Mouth sores?
   New skin rash?
   Headache?
   Fatigue?
   Nausea or vomiting?
   Poor appetite?
   Tingling, numb or painful feet/legs?
   Any other pain? If yes, where?
   Sexual problems?
Record of recent urgent medical care
Review of medications (Which medications are you taking and how often)
Assessment of medication adherence
   What problems have you had taking the medicines/°
   how taken?
   Taking any other drugs (traditional remedies, TB, ARV, illicit drugs, etc)?
   Count pills left to assess adherence
Assessment of general condition
   How are things at home?
   What usual physical activities are you doing?
   Is there anything else that you want to talk about?
Record pallor. If pallor, check hemoglobin.
Look at whites of the eye—if yellow? Look for thrush.
Patient Weight. (auto-complete weight gain or loss)
If weight loss, ask about food intake.
Assess for depression.
Look for rash
Look for evidence of violence.
Memory check
   Let patient name 3 unrelated objects, clearly and slowly. Ask patient to repeat them:
   Can he or she repeat them? (registration problem)°
   If yes, wait 5 minutes and again ask, “Can you recall the 3 objects?” (recall problem?)
Summary: overall HIV clinical staging assessment (see Appendix II for WHO definitions)
   ART Eligibility Form

The ART eligibility form is intended to asses the status of the patient prior to starting ART.

TB Assessment Form

The TB assessment form is intended to asses the status of TB. It includes the following items:
Status of coughs (>2 weeks? persistent?)
Status of fever
Unexplained weight loss?
Severe under-nutrition?
Suspicious nodes, sweats
   Pregnancy Assessment Form

Pregnancy form is intended to determine pregnancy status in fertile women. It includes the following items
Sexually status (active?)
Date of last menstruation
Using of contraceptives
Breasffeeding status
   Informed Consent

Under certain conditions, for example in the U.S., when the ARV is not yet approved by the FDA, an “informed Consent” form is required to be signed. The signed informed consent is different from all other forms since it contains the full name of the patient in it. It is kept on site and is accessible for audit purpose. In the form, in the enrollment form, there is a note to validate that “The patient has read, understand and signed informed consent form on date . . . ”

Scheduling Form

The scheduling form allows the clinicians to set the schedule for the patient's next visit. The form includes a calendar item that allows automatic selection of the date. Available dates are auto-completed. Time interval for next recommended visit is auto-completed based on clinical status.

Forms for Regional Clinic

The regional clinic will use the same forms used by field clinics, and have additional forms

Adverse Events Forms

These are standard forms. They can be customized just like any other form, to the client's specific requirements.

Lab Forms

Lab forms are an example of forms that can be filled either by manually, by the system user or by an automatic process. Lab results include results like hemoglobin, CD4 counts, viral load, etc.

The system can support two types of Lab forms:
Lab test request form—in which a patient is referred to a lab test
Lab results form—returned test results from the lab
When a lab test request form exists, the lab results form will be linked to it and the patient associated.
   Online Patient Diaries and Online Knowledge Base

Online patient diaries are an optional feature that allows well educated and cooperating patients to administer self help, and assist clinicians in assessing disease progress and treatment adherence.

The knowledge base is a basically a website that includes relevant information (scientifically published articles, news items from leading magazines, etc) and tools that facilitate community support (message boards, FAQs, etc) and help in education and compliance.

Online patient diaries are intended to be used with thin client and voice access (IVR).

Sample Use Cases

Some use cases are detailed herein as examples, without limiting the scope of the invention.

Use case I: patient is under ARV and uses his/her patient diary to monitor the use of medication, and to monitor his/her own progress.

Use case II: patient is experiencing an adverse reaction to medication, or suffers from a dramatic change in conditions.

Use case III: patient needs community support, and want to gain knowledge and insights on other people's coping with the disease.

Features

Login

Before accessing the system, the patient needs to log in using username/password or patient ID/PIN. Depending on local system administration, the knowledge base may be accessed without authentication.

Email Alerts

Patient can register to receive alerts on various conditions these include:
Lab results came back from the lab
Reminders of upcoming scheduled appointments
Answers posted to questions the patient asked in the user forum section
Schedule medication reminder
   SMS and IM Alerts

Patient can register to receive alerts on various conditions, similar to email alerts, to be sent to a mobile phone, pager, or instant messenger client using text messaging. This is particularly important for the reminders of medication.

FM Alerts via MSN Direct or Similar Service

A key need is to send patients reminders of medication. Specifically because most patients get a combination of several drugs, each with a different medication regimen, confusion can occur. The consequences of incompliance can be dire because of the risk that the virus will develop drug resistance. Patients need a method of alerts via a device that is with them all the time, wherever they are, that is always on, and that has good communication capabilities, so that changes in the medication regime are immediately reflected in the alerts (i.e. a PDA needs synchronization, which creates latency)

Patient can register to receive alerts via MSN direct (or similar service) known to those skilled in the art.

Access to Personal Record and Online Diary

The online diary allows the patient, once logged in, to access parts of his/her medical record (i.e. lab results) and to log his or her own progress according to the treatment regime.

Knowledge Base

The knowledge base will consist of a searchable library of documents that include publicly available data on HIV/AIDS, particularly documents aimed at self help and education regarding the risks and compliant behavior.

In addition the knowledge base will include a section for Frequently Asked Questions, and a user forum where users can post questions, and respond to each other, offering community support.

Data Import from Lab and Medical Devices (including CD4/CD8 and Viral Load Counts)

Use Cases

Use case I: Patient comes to first level facility; blood is taken and is sent to regional clinic for CD4 count. Sample should be synchronized via bar-code and when results come back, should be integrated back into patient's record.

Use case II: Patient is under ART, and clinician suspects a drug resistance problem. Samples need to be sent to genotypic and phenotypic analyses. When available (14 days), results should be integrated back into the patent's record, the patient and medical stuff should be alerted, and a process should alert clinician of new results, and implications.

Features

Specimen Bar-Coding

The system may have a bar-code reader interface to read pre-printed labels, and the ability to print new bar-coded labels. These labels are used to identify specimen sent to the labs.

Laboratory Information Management System (LIMS) Interface

The system will have interfaces to standard LIMS systems, where available (.e.g. LabAdvantage, Innaphase Watson, Winlims, Starims). The interface will allow for automatic import of lab results into the patient records via standard protocols (HL7, XML)

Users with administrator rights will get access to field mapping wizards that will allow them to define mapping of data-streams coming from LIMS onto the relevant forms.

Manual Entry of Lab Results

Where automatic interface to LIMS is unavailable or where a specific test results is not available in through a computerized interface, the system will have, through the appropriate forms, the capability to enter lab results manually. Where results are obtained automatically, the applicable lab result form fields will be auto-completed.

Lab Results Monitor

A special process will be activated when lab results become available, in order to trigger appropriate reports to which newly collected data is significant. This can include sending messages to patients and clinicians according to their alert profile, and triggering of data mining process that alert clinicians of anomalies and changes in the patient's condition.

Medication Dispensing and Management

Antiretroviral therapy is the course of medications or drugs taken to fight HIV. A few terms are used interchangeably to describe the same term, and include “HAART” (Highly Active Antiretroviral Therapy), “ART” (Antiretroviral Therapy), “therapy,” “antiretroviral drugs (ARV),” “HIV treatment,” “medications,” “drug regimen,” and “HIV drugs.” Antiretroviral therapy keeps HIV from replicating within the cells of the immune system. If HIV cannot replicate inside the immune cells, it cannot attack the immune system. Different drugs work at different points to stop replication. The fewer HIV cells in the immune cells, the healthier the immune system is and the better able the patient to fight off infections that can lead to AIDS.

HAART is the term used to describe taking a combination of antiretroviral drugs, usually 3 or more daily. The drugs taken as part of HAART are not a cure for HIV or AIDS but they work to keep the infection under control. Since HAART became available in 1996, the death rate from AIDS in the United States has been cut in half. These drugs often have side effects. At this time, people living with HIV/AIDS must take these drugs for their entire lives. If taken properly (the right dose, at the right time, everyday), the drugs can slow HIV disease progression and keep people healthy for a long time, often for many years. If taken improperly, however, it can lead to the virus developing resistance to medication. The challenge of clinicians therefore is to be able to closely monitor the status of the immune system, the presence or absence of the virus and potential development of drug resistance, and based on this information to apply a strict medication regime that matches the patients condition.

Medication and Medical Supplies Dispensing and Management Tools

Use Cases

Use case I: program manager wants to know the status of current medication supplies in her area of responsibility for accountability and planning purposes.

Use case II: a drug that was previously missing due to short supplies becomes available through re-stocking. Staff at first level facilities should be notified.

Use case III: a new drug is approved for use in the market. Clinicians and patients need to get information on drug use and potential side effects.

Features

Medical Supplies Inventory Tracking

Special forms allow local site administrators to update the status of incoming supplies (manually or via bar-code). The data is used to update the list of available medication. That is available for use.

Low Quantity Alerts

When a specific medication or other medical supply drops below a pre-set level, an alert is sent to the site administrator and program staff. Local administrator can define the thresholds for alerts.

Medical Supplies Knowledgebase

As part of the knowledge base detailed reports on the effects, directions of use and side effects of new medication is available to patients and clinicians.

Prescriptions

Use Case

Use case I: clinician assigns ARV to patient, based on a treatment sequencing plan.

Features

Prescription Printout

Clinician is able to prescribe drugs from a pre-populated list of available drugs. The prescription can be printed out together with directions of use and potential side effects. Where applicable, the system will print out a pill box diagram, for use with pill-boxes that have all drugs for the next month ordered in the right sequence.

The medication given is subtracted from the supply inventory list.

Treatment Sequencing and Recommendation Plan

Treatment sequencing is basically a long-term strategic approach to antiretroviral therapy. By utilizing information that is known about how resistance develops when certain drugs are used, healthcare providers can formulate combinations of drugs that will preserve more treatment options when therapy failure occurs later on down the road. This approach requires specific planning up front as well as diligent maintenance, including strict adherence to treatment. Sequencing is ideally used in people who have not yet received antiretroviral therapy, but can be effective in treatment-experienced people as well.

This feature allows the clinician to plan the drug sequencing and coordinate it with the patient. The clinician will be able to specify the treatment plan in a Gant like chart that will visually display the types of medication and the projected sequence of their use. Available medication could be selected from a pre-populated list that is updated automatically.

Data Mining and Reporting

Types of Data to be Mined

Before the development of viral load monitoring, which came about in the mid to late 90s, physicians did not have an effective tool to directly measure disease progression and the effectiveness of therapeutics. Physicians could only monitor the destruction of the patient's immune system by performing CD4/CD8 cell counts. CD4 and CD8 are two types of cells that are slowly destroyed by HIV and cause the devastating immune deficiency syndrome of AIDS.

Alone, this cell monitoring was not an effective disease management method because it provided no information about viral activity-it only demonstrated to status of the immune system. An HIV infected individual can have normal CD4/CD8 cell counts for years, even as viral load increases, then suddenly their cell counts can drastically fall, opening the door for the rapid development of AIDS.

A CD4 cell is a lymphocyte (also called a T4 cell), which is a type of white blood cell in the body that fights infection. A CD4 cell count test gives information about how many of these cells are in the blood. The more of these cells present, the healthier the immune system is and the better able a patient is to fight HIV infection. By measuring the CD4 count, a clinician can asses how weak or strong a patient's immune system is, whether to start antiretroviral therapy or how to change the medication regime, once therapy started.

A low cell count means a weak immune system. The higher the measure the better. CD4 cells are measured in cubic millimeters (cells/mm3). Someone with a strong or healthy immune system has between 1,000 and 1,200 CD4 cells per milliliter of blood (written as, 1000 cells/mm3 to 1200 cells/mm3). Individuals with fewer than 200 CD4 cells are considered to have AIDS (as defined by the Centers for Disease Control and Prevention) and are in danger of serious illness because the immune system is weak.

Although CD4/CD8 cell monitoring is still a requisite part of HIV disease management, it has been complemented by newer technologies and methods that providing a more comprehensive and successful management protocol.

A viral load test measures the amount of HIV in the blood. Measuring viral load lets physicians determine the effectiveness of a therapeutic regimen. The HIV virus is capable of mutating rapidly to develop drug resistance. Viral load monitoring indicates when that resistance occurs so changes can be made in the treatment protocol resulting in a more effective outcome. Significant increases in viral loads indicate that the current drug therapy is no longer effective. In other words, a viral load test assists the clinician in deciding how vigorously HIV is attacking the patients immune system, assessing the probabilities that the patient is developing or progressing to AIDS over time, and most importantly, assessing whether antiretroviral therapy is working or whether a change in medication is necessary. It can also indicate a compliance problem, or a misuse of the medications.

Viral load is measured in copies per milliliter (copies/ml) or about one drop of blood. For example, a reading of 5000 RNA copies/ml means you have 5000 virus particles in a specific amount of blood. A viral load reading can range anywhere from less than 50 to over 1,000,000 copies/ml of blood. The goal of therapy is to lower the amount of HIV virus in the blood as much as possible and to keep it lowered as long as possible. The best situation is when the virus is “undetectable,” which means that it cannot be detected by the viral load test. This is often reported as “less than 50 copies/ml”. Such a test result does not mean that there is no virus in the body. It means that the patient still has the virus, but the level is too low for the test to measure it in the blood. Of course, this is a good sign that the therapy is working.

An open problem with both CD4 counts and viral load tests is the variability and differences among different labs and different equipment. If blood is sent to a new lab, there may be some differences in the test results reported. A related problem is that both types of tests produce different results at different times of day.

In addition to CD4 counts and viral load tests, new monitoring techniques include genotyping and phenotyping test for mutations (genetic changes) in the virus and viral susceptibility to therapeutics (resistance), respectively.

Drug resistance happens when HIV adapts, grows and multiplies while antiretroviral drugs are being taken. HIV is considered to be resistant when a drug or drugs stop(s) working to fight the virus. Drug resistance is the most common cause of HIV treatment failure, and although drug resistance happens most often while a person is taking antiretroviral drugs, it is possible to have resistant virus without ever having taken antiretroviral drugs before. Resistance in people who have never taken drugs (treatment-naive) happens when they are infected by a person with drug-resistant HIV. Therefore, it is possible for someone newly diagnosed, and not yet on antiretroviral treatment, to already be resistant to one or more of the drugs used in HIV therapy.

Although genotyping does not directly test for resistance, it can be used to indirectly measure drug resistance because some mutations are known to be resistant. Genotyping is less complex, expensive and time-consuming than phenotyping. However, phenotyping is slowly joining the HIV management protocol.

Genotyping assays detect drug resistance mutations that are present in the relevant viral genes (i.e., reverse transcriptase and protease). Certain genotyping assays involve sequencing of the entire reverse transcriptase and protease genes, whereas others use probes to detect selected mutations that are known to confer drug resistance. Genotyping assays can be performed rapidly, and results can be reported within 1-2 weeks of sample collection. Interpretation of test results requires knowledge of the mutations that are selected for by different antiretroviral drugs and of the potential for cross-resistance to other drugs conferred by certain mutations. Various techniques such as rules-based algorithms and “virtual phenotype” are now available to assist the provider in interpreting genotyping test results.

Phenotyping assays measure a virus's ability to grow in different concentrations of antiretroviral drugs. Automated, recombinant phenotyping assays are commercially available with results available in 2-3 weeks; however, phenotyping assays are more costly to perform than genotyping assays. Interpretation of phenotyping assay results is complicated.

In sum, the invention, as applied to HIV Data Management, data mining system is aimed at providing support for the necessary decisions along the course of treatment. A key challenge of the clinicians is to assess the aggregated patient situation, and to select the best treatment option. The clinician needs to understand at what clinical stage of the disease the patient is under; is the treatment working, and if is not, how to change it. In order to assist in this analysis, the system will display various data in a clear and easy-to read manner.

This data will include both lab results (including CD4 counts and viral loads) as well as changes to the medication regimen, and other patient information (i.e. weight) that are indicative of the above. The system will further include data-mining models and tools that assist in the selection of ARV drugs and their sequencing. In addition the system will include alerts for changes in the data that will assist the clinician in identifying anomalies and suspected deterioration in the patient's condition.

Drug Sequencing Decision Support and Alerts on Potential Adverse Events

Often multi-drug combination therapies eventually fail because of the development of drug resistance. To date, there is no conclusive theory of HIV drug resistance, but a number of specific sequence mutations in the HIV genome are known to be associated with increased resistance to certain drugs. As noted above, Genotypic and Phenotypic assays are now used to analyze drug resistance and to help plan the sequence of drugs a patient needs to take. The objective of a drug-sequencing plan is to improve the personalized HIV patients' treatment by identifying drug resistance in advance and avoiding it in treatment. The process of achieving this involves first identifying drug-resistant HIV mutant strains that already exist in the patient (the rapid mutation of the HIV virus results in a population of related virus strains that are often consisting of a dominant strain and several minority strains) and then recommending a customized treatment strategy designed to avoid selection of such mutants. The result is more precise treatment of individual HIV patients and a decreased tendency to select for drug-resistant genes in the global HIV gene pool (Lathrop et al. “Knowledge-Based Avoidance of Drug-Resistant HIV Mutants”, AI Magazine 20(1): Spring 1999, 13-25)

However, with the increasing numbers of FDA-approved antiretroviral drugs and drug resistance-associated mutations, interpretation is becoming increasingly difficult. Some 18 ARV drugs are now are available for prescription fitting in three classes: protease inhibitors, nucleoside reverse transcriptase inhibitors and non-nucleoside reverse transcriptase inhibitors. These drugs could be prescribed in cocktails of a few drugs (typically no more than 3-4).

Interpretation is complicated because the influence of a certain mutation on drug resistance cannot be considered independently of other mutations, rather, it is exactly the different types of interactions that are significant. Furthermore, viruses may exhibit varying degrees of cross-resistance even to drugs to which the patient has not yet been exposed (Beerenwinkel et al. “Diversity and complexity of HIV-1 drug resistance: A bioinformatics approach to predicting phenotype from genotype” Proc Natl Acad Sci USA. 2002 June 11; 99 (12): 8271-8276). Finally, information related to the Viral load and CD4 count could be used in order to better infer the effectiveness of the drug treatment and the suggested change in treatment.

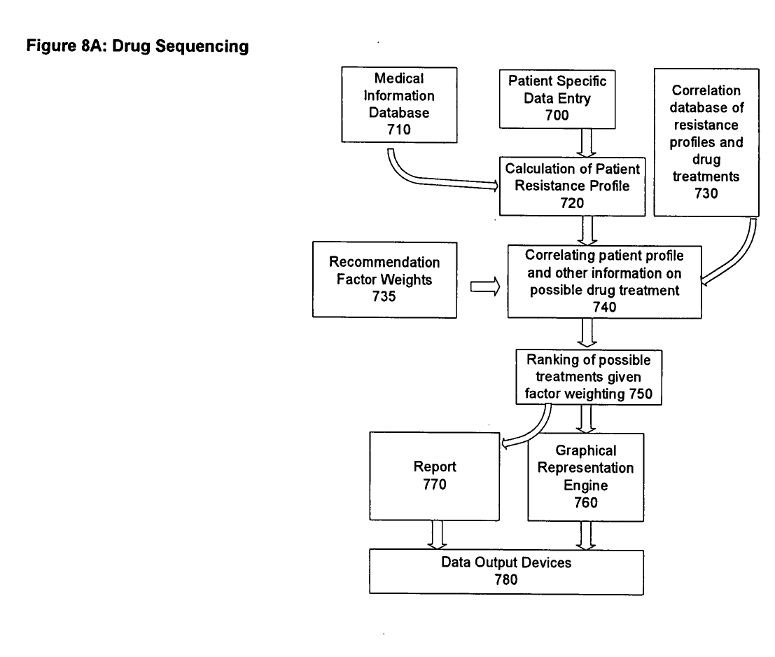

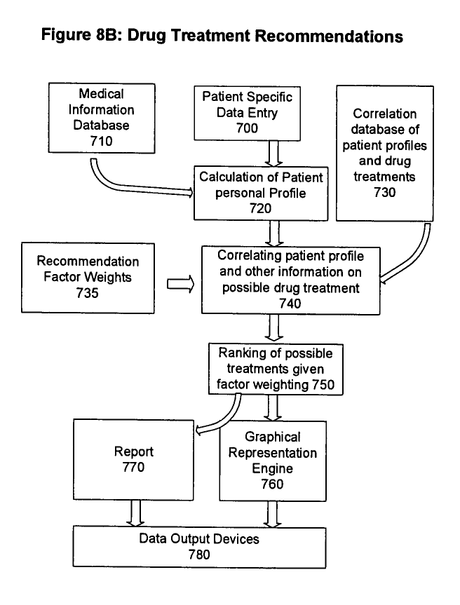

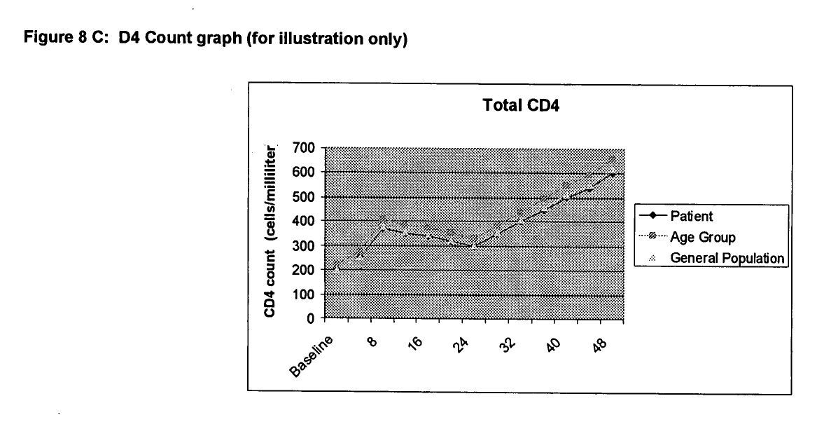

In principle, a full drug sequencing decision support system utilizing the invention may achieve the following tasks, which are illustrated as a process flow diagram in FIG. 8A:
Identify the patients current resistance situation and predict susceptibility to future resistance (720 in FIG. 8A), using patient medical data (700 in FIG. 8A) and general medical information such (710 in FIG. 8A). Starting from the patients current resistance status, further rules are systematically applied in order to predict potential viral mutations, and the associated resistance levels. Even treatment-naïve patients can exhibit resistance (e.g. if they where infected by a virus strain that is resistant.) let alone patients that have been prescribed ARV drugs already, and which have suffered from treatment failure as a result of drug resistance in the past.

The main two method of identifying resistance are by using Genotypic and Phenotypic assays. Additional information that could be used relates to the CD4 count and viral load measures, as well as general health information pertaining to the patient (e.g. temperature, skin status, pains). By identifying the genetic makeup of the virus in the patients blood along with the information in the CD4 viral load counts, it is possible using a rules based-engine to infer with high probability which drugs or combination of drugs could be effective in treatment and which drugs or combination of drug would suffer from resistance.
Item 740 in FIG. 8A describe the step of Identifying drug sequences that would avoid resistance as much as possible. Once potential mutations have been identified, the method is to evaluate the alternative drug combination and their potential suppression of mutant combinations, while at the same time attempt to minimize the number of adverse events and consider other alternatives.

The mechanism of doing so is first to consider the set of conceivable combinations and examine the forecasted impact of such treatments with the patient resistance profile. Each drug in a drug ‘cocktail’ suppresses one or more mutants but only the combination of the right drugs, in the right sequence will yield optimal results. The objective, then, is to identify drug combinations such that no nearby mutant resists every drug.
Item 750 in FIG. 8A is the ranking of the different treatment options based on effectiveness, drug availability, cost and other parameters, as weighted and entered to the computer by the clinicians or experts (item 735 in FIG. 8A). Deciding which drug or combination of drugs to use (or not to use) should take into account the drug resistance but also demographic information, and the patient's background. For example, patients are less likely to adhere to a complicated regimen requiring dozens of pills over the course of a day. Further considerations are side effects and toxicity that change as the combination of drug changes. And at least as important are drug availability and costs. Each of these factors could be coded with a weight function, and the result is a plan for a drug sequence.

The results could be presented in a report (760 in FIG. 8A) and reported via an output device such a computer screen (770 in FIG. 8A).

Similar mechanism could be used of alerts regarding potential drug interactions, or potential adverse events as a result of utilizing a particular drug regimen, given the medical profile of the patient. For example, a database to be utilized could include the potential drug interaction of Advil with people with high LDL (“bad cholesterol”) level. Such method will output an alert whenever Advil will be prescribed to a patient with diabetes. FIG. 8B describes the process. Patient specific medical information is entered to the system (Item 700 in FIG. 8B). Utilizing general medical information (710), a personal medical profile is derived (item 720). Such general medical information could be definition of disease given set of medical results of a patient.

The risk prediction model is a method that utilizes a database of known interactions given a particular patient profile and a particular drug or drugs prescribed with a specific dosage and frequency (730). Information on such database could include the likes of “using Propecia for patient with low blood pressure could result with death”. Factor weighing of type of adverse events and their severity could be added in item 735.

Possible treatments are then ranked in 750 according to the risk of having an adverse events and their severity, given a specific drug regimen (type and frequency of a drug) and the personal profile, as weighted by the factors in item 735. The results are then displayed in a report—770 or a visual display—760.

Features

Visualization of Current Virus Mutations and Drug Resistance

The system can integrate lab reports coming form various sources in a standardized, easy to read graphical manner. The clinician will have a human-readable ‘dash-board’ that in one screen will show recent medication regimen, CD4 and viral load counts, current side effects and general patient health indications, and current drug resistance and mutation data.

Determination and Visualization of Potential Drug Combination

The system allows accommodating one or more of scientifically proven algorithms or databases of drug interactions, and each one of them could be further enhanced by using information added as time goes by and as more users are using the system.

Several of these databases and algorithms that could be used as part of the method are described in:
Rousseau M N, Vergne L, Montes B, et al. Patterns of resistance mutations to antiretroviral drugs in extensively treated HIV-1-infected patents with failure of highly active antiretroviral therapy. J Acquir Immune Defic Syndr 2001; 26(1):36-43.
DeGruttola V, Dix L, D'Aquila R, et al. The relation between baseline HIV drug resistance and response to antiretroviral therapy: re-analysis of retrospective and prospective studies using a standardized data analysis plan. Antivir. Ther. 2000; 5(1):41-48.
Vandamme A M, Van Laethem K, De Clercq E. Managing resistance to anti-HIV drugs: an important consideration for effective disease management. Drugs 1999; 57(3):337-61.

For example, the system could be improved by the manual addition of decision support rules for prioritization of any particular drug of drug cocktail under certain patient conditions.

Based on the results of this data mining, the system will visualize potential drug combinations that are appropriate for the patient's current state. Such visual reports will include the list of drugs, the sequence and timing by which they should be administered, and potential side-effects and risks of toxicity associated with each combination.

Decision Support for Drug Sequence Selection

The system will supply a recommendation for the applicable drug combination. The clinician will be able to input his assessment of the patient's compliance level (for less adherent patients, a less complicated regimen will be recommended, since the implications of non-adherence out-weigh the potential benefits of a more effective but less likely to be followed drug sequence). The system will check drug availability according to current inventory. According to the level of complication and available inventory, the system will select the drug combination that has the best potential to prevent resistance. Other factors could be considered, such as the cost of the drugs. The clinician or other persons could therefore fine-tune the recommendation mechanism.

Given the factor weighting, the system then displays a list of the top drug sequences that are most appropriate for the situation.

Patient Based Progress Reports

Use Case

Use case I: A patient who is diagnosed with HIV, but is not getting ART, comes to the regional clinic for quarterly CD4 count. The clinician needs to decide ART eligibility.

Use case II: A patient on ART is suffering from sudden weight loss, and other conditions indicative of a WHO Stage 4 clinical condition. The clinician suspects a drug resistance problem, and needs to change medication regimen.

Use case III: A patient's viral load drops to the ‘undetectable’ level. Clinician needs to decide on upcoming treatment plan.

Features

Lab Results Charts and Visualization (Including CD4 Counts and Viral Load)

A key feature is the production of graphs that visualize in an easy to understand, standardized manner the lab results on an on going basis.

Graphs will include linear and/or logarithmic scales, and will include scales, indicating normal values. Graphs will include clear visual indications of normal values and extreme values using color coding.

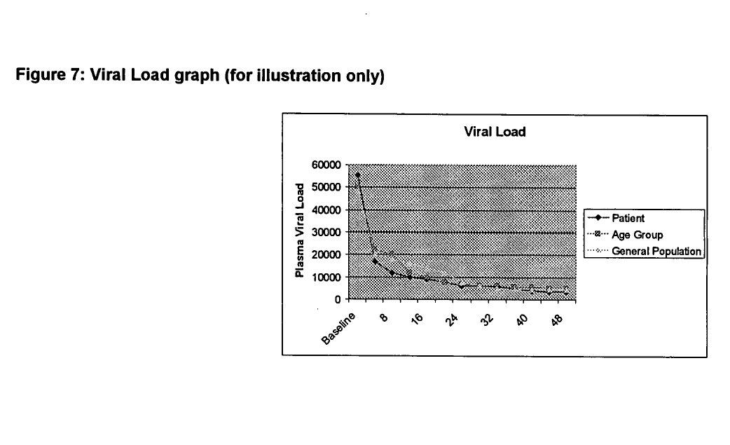

See FIG. 7 and FIG. 8C illustrate a Viral load and CD4 count graph respectively along time from beginning of the treatment. Graphs will indicate individuals' readings and the clinician and other users of the system could overlay the patient's graphs over graphs of the general HIV infected population, or any one or more of subgroup. For example, average of treated persons with the same age group.

The reports can be viewed on screen or printed.

Phenotyping and genotyping and drug resistance reports

(source: http://www.phenosense.com/viro/1335.asp)

Phenotypic testing is performed by placing samples of a patients HIV in contact with antiretroviral drugs to observe how the virus reacts. it is referred to as being a direct way of measuring drug resistance. Phenotypic testing is quantitative because it is possible to evaluate how much of a drug is needed to stop HIV from growing. This type of detailed information can be valuable to a healthcare provider in making more effective treatment decisions.

Genotypic testing looks for the presence of genetic changes, or mutations, in HIV to predict resistance to antiretroviral drugs. If the mutations found in a person's virus match the mutations that are known to cause resistance to a drug, then his or her virus is presumed to be resistant to that drug. The critical aspect of genotyping though is not identifying mutations but rather in the interpretation of the results—in other words, making sense of all the different mutations and how they interact with each other to affect drug susceptibility.

If genotypic testing reveals drug resistance mutations in a person's HIV, certain antiretroviral drugs may be less likely to work. For example, if the “M184V” mutation is discovered in a person's HIV, the virus is probably resistant to 3TC. A computer can be utilized to capture a large set of such links, and be optimized to develop a treatment plan that avoids the use of those drugs, resulting with a more effective drug regimen. Both types of reports (or a combined report, if available) may assist the clinicians in planning the long term treatment plan (drug-sequencing).

Replication Capacity Report

Replication Capacity (RC) measures how well a patient virus is able to replicate compared to a wild-type reference virus. Although drug resistance mutations enable viruses to replicate in the presence of drug, they may do so at some fitness cost to the viruses.

Subtype Report

Knowing the subtype of a patient's virus can provide useful information for treatment planning. Although subtype B is the predominant strain of HIV-1 in North America, non-B subtypes are becoming more prevalent.

This report will assist the clinician in planning long-term treatment (drug sequencing), since non-B subtypes develop resistance through different mutational patterns than subtype B for most drugs.

Medication Regimen Report

The report may include a visualization of the medication regimen, and its changes. The report will indicate existing medication regimen, past medication regimen, and comments entered by clinicians at points where medication changes where prescribed. The report will also highlight for any particular patient the level of adherence to the regiment. For example, there could be a calendar on top of which medication miss will be highlight in red.

Treatment History Report

The treatment history report is a summary report that assists the clinicians in getting a snapshot of the patient's course of treatment thus far. This report is especially important in situations of high case-load in which the clinician needs to decide on the course of treatment in a rapid manner based on all available information. The report mayl include a summary of treatment, medication and lab results data.

Alerts for Necessary Intervention

Alerts are automatic message that are generated based on the occurrence of a set of pre-defined conditions (the alert rule). Alert rules are pre-defined by alert-rule templates and can be locally adopted by a site administrator.

Alerts can be accumulated in a special section of the patient record, ready for review when the patient visits the clinic, or they can be pushed via various communication means to the patient or to the clinician (e.g. via email, sms, Instant messaging etc) Possible Use Cases

Use case I: based on on-going collected information, and lab results as they become available, clinician needs to be alerted to sudden changes in patient's condition that may imply a necessary change in treatment (i.e. starting ART, changing medication)

Features

Alert Rule Set-Up

For each alert, a rule is set up that defines the conditions for triggering the alert. Rules can be set up using a rule wizard (similar to Microsoft Outlook mail handling rule wizard). Rule may include one or more conditions for triggering the alert, and one or more actions to be taken when the alert is initiated.

For each type of alert, a default template rule is set up, and derived rules can be set up by local site administrators.

Alert on Sudden Loss of Weight

Alert may be initiated when the ongoing weight measurement indicates a sudden drop in patient's weight that can be indicative of advancement of clinical staging.

Alert on Drop in CD4 Count

Alert may be initiated when lab results indicate a sudden drop in patient's CD4 count that can be indicative of disease progression. This may indicate the need to start ART for patients who are not on it already, and may indicate a drug resistance problem.

Alert on Increase in Viral Load Count

Alert may be initiated when lab results indicate a sudden increase in a patient's viral load count that can be indicative of disease progression. This may indicate the need to start ART for patients who are not on it already, and may indicate a drug resistance problem.

Alert on Drug Resistance Susceptibility

Alert may be initiated if lab results indicate that there is a change in drug resistance.

Alert on Change in Recommended Treatment or Additional Tests

Following the change in the patient's status and or adherence levels, as evidenced by results such as CD4 and viral load, the system may issue an alert recommending altering the drug regime being used. For example, a patient that has deteriorating adherence level may be switched to a drug regime that requires less pills a day. Another example is a patient who exhibits severe side effects with a particular drug cocktail. The clinician of that patient is recommended to switch to an alternative drug treatment which may have lower probability of success, but higher likelihood of less adverse events, which in turn will guarantee high level of adherence. Similarly, an increasing level of viral level, stabilization of CD4 count coupled with an increase in patient temperature may trigger an alert suggesting higher likelihood of viral resistance. This could trigger an alert suggesting an additional genotyping test.

### EXAMPLE OF COHORT BASED REPORTS

Use Cases

Use case I: program administrator wants to get data on the progress of the disease management program

Use case II: to solve resource allocation problems, the program administrator together with the regional clinic stuff want to decide on local guidelines of starting ARV. They need information on the amount of patients at the different stages of disease progression, and ranking of patients that are likely to benefit from ARV.

### EXAMPLES

Cohort Clinical Staging Report

This report summarizes the statistics of clinical stages of the patients being tracked by the system

Death Rate Report

This report summarizes death rates of patients in the program

Patients Currently on ARV

Reports current patients that are on ARV

Patients Eligible for ARV According to Criteria

Allows to define the criteria for ARV eligibility (based on CD counts, weight trends, etc), and get a list of patients that would be eligible.

Patients Status Based on Medication

Allows to view the status of patients that are on a specific medication.

Alerts for Anomalies and Change in Trends

An alert may be initiated if for a sufficiently large (pre-defined) group of patients a parameter collected by the system experience sudden changes. Such a change may indicate of a system miss-use or failure, or it may indicate

User Defined Reports

The system may support customization of reports and creation of more report templates at the local site administrator level.

Mapping Based Reports and Visualization Tools

Use Cases

Use case I: program administrator wants to get information about geographic distribution of patients in order to plan resource allocation for first level facilities.

Use case II: program administrators wants to assess infection rates at a given geographic areas so that education efforts can be better focused.

Features

Integrated Mapping

A Geographic Information System (GIS) package may be integrated into the system to facilitate various map based reports.

Patient Distribution by Region Report

A map report showing patient distribution by region.

System Administration

The invention is a dynamic, modular system, that comes with built-in templates for easy set up and use, but that preserves a high degree of flexibility and configurability throughout its life-cycle from deployment through use.

A special class of users—administrators—have access privileges that allow them to change many of the parameters of the system operations (e.g. change the forms, map data streams for import/export of data, manage users, etc). This allows for configuration of the system for changing scenarios, and use of different modules as the needs arise, and as the resources permit.

The following sections describe the elements of system administration.

Authentication

To preserve the security of the system, and to enforce the privacy of the data it crucial that only authorized personal can enter the system. To check whether a user is authorized, his identity must be authenticated first. The authentication process must verify that the user using the system is the stated user.

Users may enter the system using thick or thin clients, or using a phone

Site Management

This module manages system sites. Sites are administrative units that could be part of the same organization or be independent (e.g. a first level facility is a site, a lab is a site) Their definition may include:

| | |
|---|---|
| Site name | Text |
| Site address | Text |
| Site Telephone | Phone |
| Site administrator | User |
| | account |
| Site co- | User |
| administrator | Account |

During the creation of a new site, the administrator can create a new user a site-specific Site Administrator, or, in the case of a modification, to either create a new user or select an existing user for this role from a list of all the users of this site that are Administrators.

User Management

The application may have a built-in account with a username of Administrator. This administrator is able to create new users, manage existing users and disable existing users.

There are three general categories of users: Global, and Site-Specific. And there are two general categories of user roles: Global and SITE-specific. Global users have access to data across sites. Site-specific users have access only to date within their site. The management of each category of users will be handled by different administrator. Within the Global category, there are special kind of sub-category, that of the SITE-Administrator. SITE administrators can customize the system within their own site.

| Roles/users | Global | Site specific |
|---|---|---|
| Global | Add form templates, | Site administrator |
| | add sites, add other | |
| | system-users, define | |
| | items | |
| SITE specific | Site admin, Site | Site- administrator, |
| | monitors, Site | principal investigator, |
| | designers, | other investigators, |
| | statisticians, etc | data entry personnel. |

Administrative User Groups

The following groups of administrative users are available:

Global Admin: a built-in global user with permissions to add sites, templates, as well as other “global” users.

SITE Admin group: A SITE-specific group of global users, managed by the Global administrator with permissions to (add users who) define the forms of the SITE, control the stages of the SITE, join sites to the SITE, add monitors to the Site, create Site-wide reports. Site administrator must be defined or selected during the creation of a new Site

Site Admin: a site-specific user group with permission to manage (add/delete/set roles for site-specific users. Site Administrators must be defined or created during the creation of a new site or the joining of an existing site to a new Site.

Other User Groups

Managed by Site Administrators: Site designers, (with permission to create and modify the forms); Monitors (with permissions to view forms, and examine the audit trail); public health officials and others with “view only” permissions.

User Interface (UI) for User Management

Access to UI

Different administrators can manage different users and user groups. In general Global and Site administrators can see and manage only global users (with the exception of the special site-administrator role, that's defined together with the site itself and site administrators can see and manage only “their users and groups.

User Interface

Administrators will have two main screens from which to manage users, namely, the user groups list, listing the user groups, and a user list, listing the users.

User Group Management Tool

The user-group list lists the names of all the user groups the administrator manages. There will be two hyperlinks to the right of each name, one to manage group membership and another to manage password protection policies for the group.

The membership form is consisted of a list of the names of all the users that are members of a list, and a checkbox column on the right to remove the users from the list. The form will also have an add button that will take the user to a list of the names of all the (site, or global) users, and a checkbox to the right of each. By checking the box those users will be added to the group.

The password form will allow the administrator to set minimum length and maximum age for passwords of members of the group.

Users Management Tools

Users will be displayed row by row. Each row will consist of a hyper-linked name and to its right a list of the names of the groups the user is a member of. By clicking on the user's name, the administrator will be taken to the user management form that allows the administrator to modify the users details, as well as its group membership.

| Attribute | Description |
|---|---|
| Usemame | TEXT |
| First name | TEXT |
| Middle Initial | TEXT |
| Last name | TEXT |
| Password | TEXT |
| Allowed Site | The administrator will get a list |
| | of defined Site in the system |
| | and will be able to check the |
| | ones that the user shall have |
| | access too. The administrator |
| | will be able to select “All” which |
| | will allow the user to have |
| | access to all Site. |
| Group membership | The user-group of which the |
| | user is a member. |
| Active/Disabled | Checkbox that will indicate if the |
| | user is an active user or not, |
| | disabled users will not be able |
| | to login to the application. |

Create New Site

When selecting the “create new Site” option users are directed to a new Site screen, in the new Site screen users will need to provide the following information (Y=Yes):

| Field Name | Type | Mandatory |
|---|---|---|
| Short name | Text | Y |
| Description | Text | Y |
| Site Administrator | User | Y |
| Site(s) | Reference | Y |
| More attributes to be | | |
| entered here based | | |
| on FDA guidelines | | |

In addition to the fields the page will have two buttons at the bottom of the page:
Save
Cancel

The save button will validate the form, by making sure all mandatory field has values, if a value is missing from one or more mandatory field the page will re-display itself with the missing fields title in a red color

The cancel button will close the page without performing any action, and return to the previous Site main screen.

Edit/Select Site

Administrators can edit and select sites. For each Site the application will display the following information
Select link
Short Name
Location
Contact Name
Active flag (Y/N)
   Patient Definition

For each Site the site admin can define the fields included in the basic patient record. The application will come with a set of predefined items which the admin will be able to select from as defining the patient record and in addition she will be able to add her own items to that definition. Adding the fields will be done in the same manner as adding item to a form.

Upon entering the “Patient Definition” screen, the admin will get the list of the predefined fields. Regular users (non-admins) will be able to change the text for these items but will not be able to change any of the attributes for them.

To the left of each field there will be a checkbox to indicate if field is an active field for this Site. A checked check box will indicate that this field is a used field, if the field is not an active field the other attribute will be disabled.

Bellow is the list of the pre-defined fields:

| Field Name | Type |
|---|---|
| First Name | Text |
| MI | Text |
| Last Name | Text |
| DOB | Date |
| SSN# | Text |
| Gender | Male/Female |
| Home Phone | Text |
| Work Phone | Text |
| Cell Phone | Text |
| Fax | Text |
| Email address | Text |
| Home Address | Text |
| State | Reference |
| Zip Code | Text |
| Usemame | Text |
| Password | Text |

Forms Administrators will have the ability to manage forms using the “edit/add form” screen in an edit mode, or to click on the items management link which will take them to the Item management screen” for this group. Users will also be able to click on the “Create new group” button that will take them to the same screen as the edit link. The “Create new group” button will be available only if the process is not an active process.
Edit/Add Form

If entering the screen in an edit mode, users will be able to update the group name, description and type. In case the selected process is an active process users won't be able to make any changes and will be able only to view the information. If entering the screen in an add mode, users will get an empty screen and will need to provide the information for the new form.

The following fields will be displayed when add/editing a form (Y=Yes):

| Field Name | Type | Mandatory |
|---|---|---|
| Group Name | Text | Y |
| Group Description | Text | Y |
| Gender Specific | Male/Female/All | Y |
| Fixed schedule | Yes/No | Y |
| Times available for | 0/1/2/3/4/unlimited | Y |
| non-scheduled | | |
| fillings | | |
| Force Mandatory | Yes/No | Y |
| fields upon first entry | | |
| Allow for patient | Yes/No | Y |
| entry | | |
| Number of entries | Number | Conditional |
| Requires Double | Yes/No | Y |
| Entry | | |
| Blind Double Entry | Yes/No | Conditional |

For the group type users will need to select one of the following options:
One time form
Repeating form—No limit on number of entries
Repeating form—Limit on number of entries.

A one time form means that the users will need to answer the items in this group only once per patient in the entire process (e.g. demographic information).

A repeating form with no limit on the number of entries means that the users will be able to answer the same items in this group from 1 to n number of times (e.g. patient weight)

A repeating form with a limit means that the user will need to enter the number of time that this form needs to be entered. This number can be between 2 to n.

If the group type is repeating form with a limit on number of entries a field that will represent the number of required entries will appear and will be a mandatory field.

Item group that allows for patient entry means that patient will be able to fill out the data using a web application or other data entry points such as phones or PDAs.

Items Management

The “Item Management” screen will allow administrators to add, delete and modify the items for the specific form they are working on. The admin will see a list of existing items for this form or a message indicating that no item was entered to this form.

Defining Item Text

The item text part is simply the text that represents the item in a human readable format for the form user. When the form is for user interaction, it is typically the question text (e.g. “Patient age”). The Item Text is a default text, and administrators can override it.

Item Value Definition Part

The item value definition describes the attributes of the value that can be assigned to the item (in interactive forms—the answer to the question). It includes the value type (textual, numeric, etc.), value range limitations, and sometimes a closed set of predefined values to which the value must belong. Item Value Definition will also describe if the input value for the item is mandatory or not, and the way to handle value exceptions.

Item values can have the following types, and allows the flexibility of adding additional types:
Text
Whole Number
Real Number
Date
Time
Date+Time
Boolean
Binary (field can be assigned a generic block of data, such as a file content)
Sound
   Image Item

Images are a special case of items that the system will collect. Images give the unique ability to use photography as part of the disease management process to track visual images of the patient over time by capturing an image of a designated organ of the patient, that is related to patients' clinical condition and that doesn't expose any details that may compromise patient privacy, and track patients' visual condition over time. The system will also allow special graphical annotations on the captured images just as any other item captured.

Item Value Range

For value types of ordinal type, including numeric, date and time types, can have a lower or upper value limit, or both.

When such a limit exists, violation of the limit can lead to a warning, an error (exception) or none of them to the user in a form of a message.

Item Value Exceptions

Out of range values, missing values (for mandatory items) and other custom values can lead to generating warning or error messages, with the option of violating the form; when a form is considered violated, it cannot be processed beyond the input stage (cannot be saved, submitted, signed, etc.)—the violations must be resolved by modifying the item values, or by canceling the form input.

Item Value List

The value list defines the possible values that can be assigned to an item. The list source can be one of:
List of static values (e.g. <“aaa”, “bbb”>, or <1.0, 1.1>, etc.) that is configured in the database. The list can be customized for each item.
List of dynamic values that is concluded from other locations in the database, e.g. from previous filled forms for the patient.
   Item Group Hierarchy

Items can be grouped into an Item Group in order to create a logical association. The Item Group can be further contained in another Item Group, among other Items and Item Groups. The hierarchy can be thought of as an XML tree, where the leaves are the Items, and inner-nodes are Item Groups.

Screen Flow

General Layout Description

Both thin and thick clients will have 3 main sections to them:
Header that includes
   Logo
   Page Name
   User information
   Logout button
Main Navigation bar that includes
   Administration (administrators only)
      User Management
      Site Management
      Form Management
   Patient Management
      Patient Registration
      Details Update
   Patient Clinical Monitoring
      Forms
      Lab Reports
      Visit Schedule
      Medication
      Adverse Event Reporting
   Messaging Center
      Inbox
      Outbox
   Online Knowledge Base
      Searchable database that can be used during support and education activities and includes whitepapers, pamphlets, etc.
Content Area that changes according to the selected option in the navigation menu

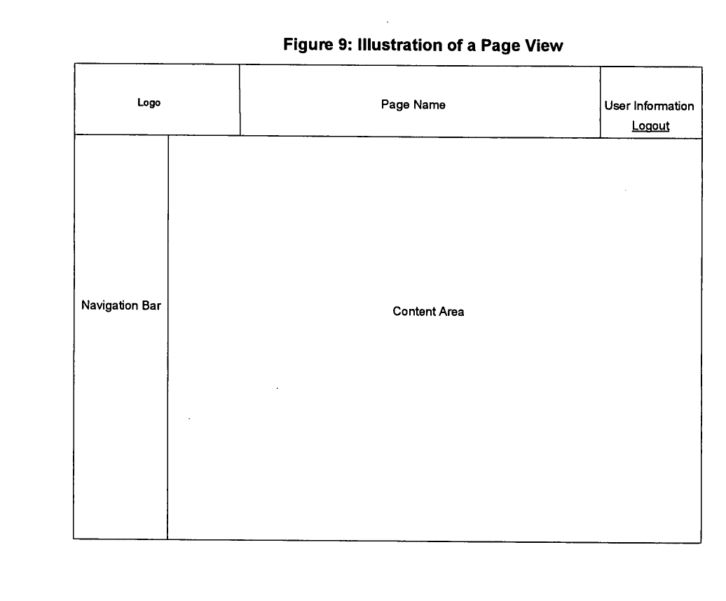

See FIG. 9 which shows an outline of a typical page in

General Screen View

Screen Flow Diagram

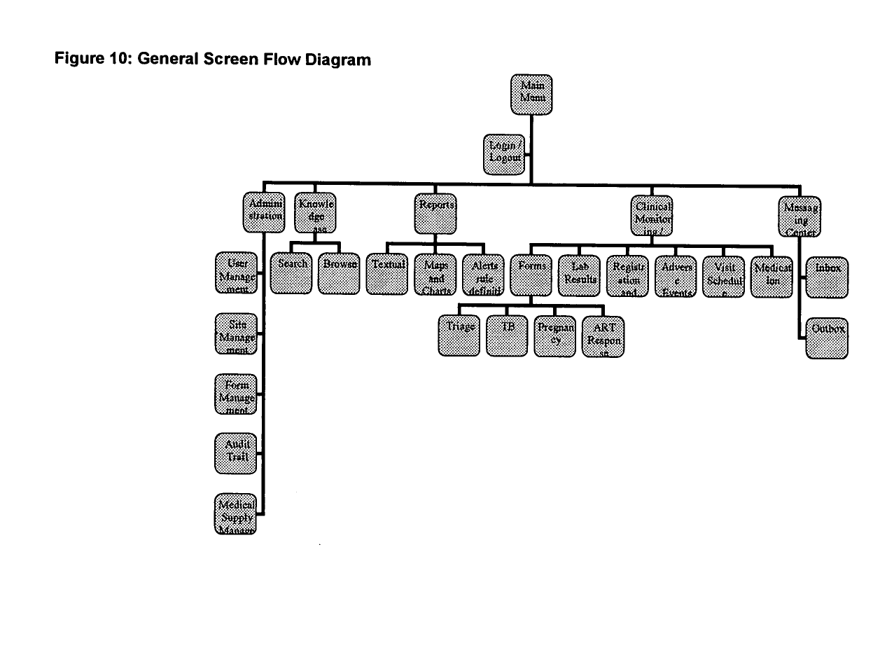

FIG. 10 the screen flow in the application

The Document Subsystem

Without affecting the generality of the invention, the described system described below is utilizing XML as the core document format.

The system is built around database storage of XML documents that are product-independent. This means that regardless of the way the documents are created, they are pre-processed to ensure “data cleanliness” before entering the database. This ensures that other services can be attached to the database, that read the XML documents, process and possibly alter them (without affecting the original), to be able to achieve various tasks such as creating a report, opening for editing, etc. The concept can be seen later in this section—with various services built around the Document Subsystem, all making use of the same core documents.

This document concentrates on initial technology aspects of document storage and viewing. Document management technologies, such as for controlling a document workflow or permissions, as well as other technologies required for the system are not covered in this document, and will be presented in other documents.

Using XML as the format for the system documents opens the door for other technologies and products, such as management and view applications, that also use XML as their document technology.

In order to be open for integrating with other modules, both internally and externally, the stored XML documents need to be:
“Pure”: the documents should contain form data only, with no product-specific or view-supporting metadata. For example, the documents should never include Microsoft InfoPath (hereafter, InfoPath) or Adobe headers. In fact, by looking at the documents, one cannot tell if they will end up being processed by Microsoft InfoPath, Acrobat Reader, Microsoft BizTalk or any other technology.
   If a product or technology require adding to or modifying the “pure” XML document in order to be able to manipulate it, such modification will not be done on the document itself but rather on a copy of it, that will not lead to changing the storage of the original. For example, this is how we prepare a document for usage with InfoPath; InfoPath requires some product-specific headers to exist in the XML file, and these are added by a special server created for this task (see Example 1 later in this document for details).
Complete: a document should not assume a specific usage, product or client that will use it; instead it should assume generic usability.
Well formed: All documents should be well-formed according to W3C's XML definition, in order to be handled by standard XML processors.

The documents themselves will not contain metadata information, such as status, signatures, comments or similar. For tools that will benefit from seeing the document together with metadata in a single XML object, the data will be integrated using one of the system services. For example, we can use InfoPath to view a form with embedded annotations. For this to happen, the InfoPath Document Server (see later in this document) will load the FORM (with no annotations), then load the annotations, combine the two into a single XML file, then serve it to InfoPath.

Description of the Document Subsystem

This role of the document subsystem is to store and retrieve the system documents (FORMs) as XML items, along with metadata, such as FORM state, flags, signatures etc. To accelerate the retrieval process, the Document Subsystems uses various methods of indexing on the core XML data. The indexing is flexible and offers client customization which enables supporting complex data retrieval scenarios.

The Document Subsystem handles the core task of document storage. Other subsystems are responsible for the various operations that are done with the retrieved documents, e.g. for serving a FORM as a viewable HTML page to the user, or exporting a FORM to some external system.

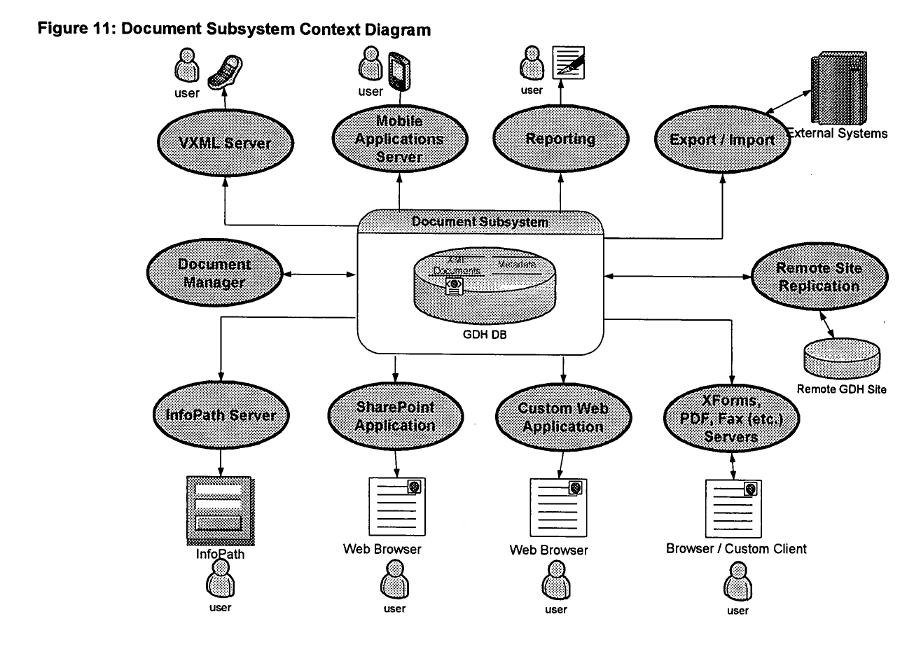

FIG. 11 shows the relationship between the Document Subsystem and other components of the system:

Control Components

The Document Manager components include the business logic (BL) modules that control various aspects of the documents such as states, signatures etc., by analyzing the current states and issuing commands to the Document Subsystem.
Export/Import components allow the logic needed for interacting with external systems, such as lab equipment (via a clinic's main server) both for incorporating external data into the system or exporting such data to the client's systems.
Event Scheduling components are responsible for connecting documents (among other system elements) with time events, such as assigning a reminder for the confirmation of a FORM.
Site Replication components are responsible for synchronizing data between installations of the system, allowing them to operate locally, with no connection to a main server.
   View Components

View components are responsible for rendering documents and document metadata into a format that can be presented to the user. The presentation format is typically a GUI, but can also be an audible format such as VXML, or any other format. In a similar way, the consumer for the view is typically a user working interactively with the system, but can also be an automaton such as lab equipment agent.

The view components are responsible for interacting with control components, in order to carry out the operations chosen by the user using the view.

Examples of typical view components in the system can include:
InfoPath Server (or similar server): Enables the usage of an InfoPath client with the document subsystem. It is responsible for rendering the documents from the pure-XML format that is stored in the database and served from the Document Subsystem to the exact format that can be handled by the InfoPath client program. It is also responsible for accepting submitted documents from the user, stripping away any Infopath-specific parts, and delivering a pure-XML formatted data to the Document Subsystem.
Custom Application: A custom application can be developed for several reasons, including cost and flexibility.

SharePoint Application: A SharePoint application can be built, using Microsoft SharePoint Services and custom “Web-Parts” (that enable custom and enhanced GUI elements), to provide a complete document management GUI to the client. Where the SharePoint GUI elements are not sufficient, specialized “Web-Parts” could be developed, which are GUI elements that are developed just like any other custom GUI solution, and can be integrated into the SharePoint GUI.

The SharePoint GUI interacts with Control Components in order to perform business logic operations (such as signing a FORM).
XForms, PDF, Fax (and other formats) server: just like InfoPath is supported as a client (using InfoPath's views to present documents), the core XML documents that are handled by the Document Subsystems can be rendered into other formats, such as XForms. This allows the development and integration of XForm-based clients and other clients using any document format—without the need to modify either the data components (the Document Subsystem) or the Control Components (such as Business Logic modules). The storage of pure-XML documents in the GDH database provides a format-agnostic storage which is very flexible for transformation to other formats. Servers can be built to communicate with fax software or hardware to send and receive fax documents.

VXML Server: just like any other view, a VXML server renders a document into a format that is presentable to the user (in this case using audio), and allows feedback (using either voice or phone buttons). The user commands are interpreted by the VXML Server and passed to the Control Components for performing the user commands.
Mobile Application Server: Mobile devices typically require a custom GUI that will take into account the special features of the device, including screen size and lack of keyboard. A Mobile Application Server (typically built individually for a specific device) can be developed to interface with mobile devices, including PDAs and smart-phones.
Reporting: reports to any kind of format are another type of view that requires the rendition of the documents into the target format (for display, printing, emailing, etc.) Another kind of report requires the aggregation of several data items, such as grouping of documents or document metadata (e.g. reporting the total number of FORMs per month).
   Integrating a Solution

The modular nature of the described technology offers a high level of flexibility when integrating a solution. The modularity is used for tailoring the best technical solution for the clients environment, whether it needs an offline solution (where we can benefit from InfoPath's features), a thin-client solution (where a web-browser can be employed) or any other technical requirement.

Following are two detailed examples of possible integrations, one that does not employ SharePoint, and one that uses it as a GUI.

Note that for the sake of simplicity, the examples demonstrate only the interaction of the view components with the data components, whereas control components are not presented (although at least one control module is necessary in the solution).

### Example 1

### A Custom Client Solution

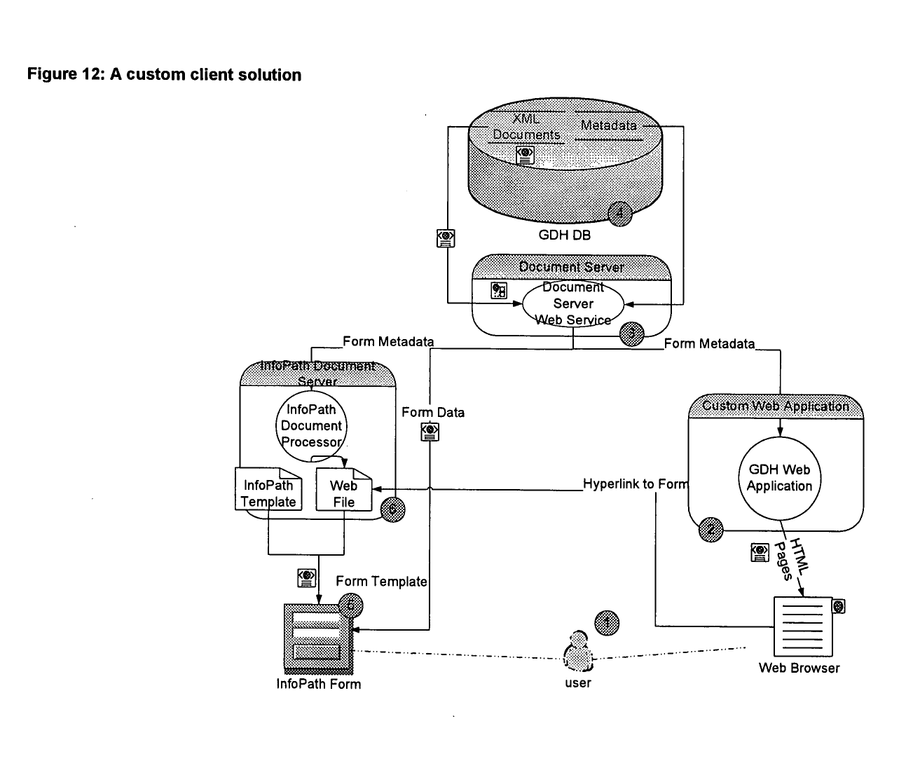

FIG. 12 demonstrates data and view components that can be used to create a custom client application that does not use SharePoint. Note that, as mentioned above, such a solution can be used both when a very simple solution is desired (whereas SharePoint might not be necessary), or a complicated solution, whereas SharePoint alone may not suffice.

In this example, a custom web application is developed to serve as a document management view, with InfoPath serving as the document viewer and editor.

The following steps explain a typical usage scenario for the example.
a. The user (1 in FIG. 12) uses the custom web application (2) as the main application, viewing task lists, timed events etc., and also document lists (typically FORMs). For example, a FORM list can include a set of FORMs awaiting the user's approval via a digital signature.
The data content of the lists is retrieved from the Document Server (3), which accesses the GDH database (4).
b. The user selects one of the documents (via a hyperlink or similar).
   (i) The InfoPath program (5) is opened.
   (ii) InfoPath loads the FORM data from the InfoPath Document Server component (6).
   (iii) The InfoPath Document Server in turn loads the FORM from the GDH database (4) via the Document Subsystem (3).
   (iv) Before the XML document is sent back to InfoPath, the InfoPath Document Server must transform the FORM to InfoPath's specific format needs.
   (v) Once the formatted XML document reaches the InfoPath program (5), the FORM is presented to the user.
c. The user edits the FORM (or creates a new FORM)
   (i) Using InfoPath (5), the user modifies or fills form fields.
   (ii) Once the form is ready, the user uses InfoPath's submit action to submit the form to the backend system.
   (iii) InfoPath calls the InfoPath Document Server (6) that strips the FORM from any InfoPath-related format.
   (iv) The InfoPath Document Server delivers the pure-XML document to the Document Subsystem (3) for storage in the GDH database (4).

This whole scenario is orchestrated by one or more control components that provide business logic features such as validating the eligibility of the user to perform edit operations, etc.

### Example 2

### A SharePoint-Based Solution

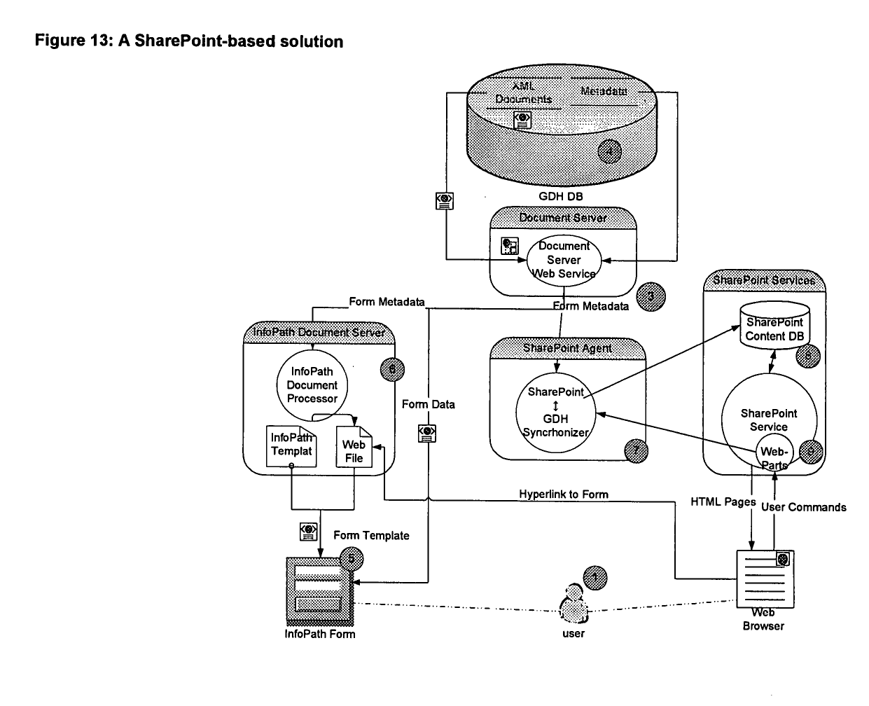

FIG. 13 demonstrates the data and view components that can be used to create a solution that takes advantage of SharePoint's features.

In this example, a SharePoint solution is developed as a document management view, possibly enhanced with various GDH-developed “Web-Parts” integrated into the main views.

To display a list of FORMs similar to the previous example, SharePoint first needs to learn of the content of the list. Since we do not use SharePoint for the storage of the FORM documents themselves, we need to use an agent that will communicate between our storage system and SharePoint. This is what the SharePoint Agent does.

The following scenario explains the steps how a document becomes accessible from a SharePoint application:
a. Assume that a new FORM is added (by any process) to the database (4).
b. The SharePointAgent (7 in FIG. 13) detects the new FORM and updates the SharePoint Content Database (8) using the SharePoint SDK. The agent would typically add a “link” to the new FORM—a link that would identify the FORM but would not contain its actual form data.
c. The user accesses the SharePoint application (9) using a web browser.
d. The SharePoint application reads list contents from the SharePoint Content Database (8), including the newly added FORM-link.
e. The user selects the document (by pressing a hyperlink in one of the lists)
   (i) A SharePoint page (that includes a GDH “Web-Part”) is opened.
   (ii) On this page, the user can choose an action to perform with the document.
f. If the user chooses to view or edit the document, InfoPath (5) is opened with the document data (in a similar way to the previous example).
g. If the user chooses some other operation, such as to delete the FORM, the request is passed to a control component (not in this chart) to validate and handle the request.

It should be understood that the processes, examples, embodiments and use cases described herein are only exemplary and any suitable permutation of them may be used and is predicted by the invention.

The foregoing disclosure and description of the embodiments of the invention are illustrative and explanatory thereof and various changes to the size, shape, materials, components, and order may be made without departing from the spirit of the invention.

While the present invention has been described with reference to the disclosed embodiments, it is to be readily apparent to those of ordinary skill in the art that changes and modifications to the form in details may be made without departing from the spirit and scope of the invention.

We claim:

1. A method for deriving illness probability for any selected person within a database of people stored in a computer and/or on a computer network, comprising the steps of:
collecting relational data from every person in the system, said relational data including whether a person has a contact relationship with another person in said database;
utilizing a data base of illnesses infection probability functions given different illnesses and states of nature including data relating to social relationship; type of disease; probability function of infection given a time unit; length of contact of the particular contact relationship link;
calculating at least one relational path between said person and each person in the data base with whom there is a contact relationship, direct or via other persons in the said database;
deriving the illness probability of the said person for each of the above relational paths by calculating the probability of the said person being infected with illness by multiplying the illness probabilities of the said person with the probability functions of the persons along the said relationship path; and
selecting the path with the highest infection probability from at least one relational paths with the highest probability calculated.

2. The method described in claim 1 where the system is further enhanced by other medical information to be incorporated in the probability of illness function.

3. The method described in claim 1 whereby the illness function is state dependent.

4. A Method of graphical representing the illness probability described in claim 1, whereby each person in a data base could be defined as the center for a disease probability view comprising the steps of:
representing at least one set of probability illness along one axis with all the people related to the person directly or indirectly or a defined subset with each person that is to be represented located along the axis at a height that corresponds to the derived probability and
connecting the lines using some initia such as color for summarizing the type of relationship.

5. A method for archiving a plurality of medical data objects within a document; the method comprising the steps of:
converting medical data objects within a document into at least two storage objects, wherein each medical data object has one or more data items and at least one storage object represents the said data items and one storage object represents the metadata of the said data object; and
combining the said storage objects to the corresponding data object.

6. The method according to claim 5, wherein said documents are XML documents.

7. The method according to claim 5, wherein said documents are used for storing and utilizing information in the context of infection probability calculation.

8. The method according to claim 5, wherein said documents are used for storing and utilizing information as part of a system for disease management.

9. The method according to claim 5, wherein said documents are clinical trials records.

10. A computerized decision support method for selecting the optimum treatment for an HIV condition in a human patient, the method comprising the steps of:
describing possible treatment profiles in a database including efficacy and toxicity of at least one ant-retroviral drug or combinations thereof used for the treatment of patients with different HIV conditions;
identifying a patient's current resistance profile using at least one of patient medical conditions comparing the patient's current resistance profile with the above database and ranking potential treatments according to the patient current resistance profile; and
providing a recommendation as to which drug or drugs are deemed optimum for treating the patient.

11. The method according to claim 10, which is further enhanced by the inclusion of additional factors for choosing a recommended treatment profile and/or for ranking the drug treatment.

12. the method according to claim 10 which is further enhanced by a parameter weigthing system to allow for the consideration of drug availability and cost.

13. The method according to claim 10 whereby the method is Genotypic or Phenotypic assays.

14. The method according to claim 10 wherein the comparison includes a CD4 count and a viral load evaluation.

15. The method according to claim 10 wherein general health information pertaining to the patient including temperature, skin status and pains is included.

16. The method according to claim 10 whereas the choosing of optimum treatment is based on a weigting of parameters as input by user.

17. The method according to claim 10, where the recommendation method takes into account at least one of the following factors: cost; drug availability;
demographic information; and the patient's background; Patient's regimen compliance history, with each of these factors coded with a weight function to be used in the ranking process

18. A method for predicting a risk of adverse events to one or more drugs for at least one patient, the method comprising:
utilizing a patient database, comprising the personal medical profile of at least one patient and genetic information of said at least one patient;
utilizing an adverse drug event database containing adverse drug event information;
connecting the patient database to the adverse events database to enable a user to determine an association between the genetic information and the adverse drug event information;
predicting a risk for adverse drug events for said at least one patient, from the association between the personal medical profile and the adverse drug event information; and
recommending to a patient at least one drug and dosage and frequency of drug taking based upon said predicted risk.

19. A method for generating alerts for the detection of emergency events such as the outbreak of an infectious disease or a biological, chemical or nuclear attack and for diseases management, the method comprising of:
collecting data from a plurality of sources such as consumers, patients, medical sensors, medical institutions, governmental agencies where such collected data includes at least one source of information that is collected from a patient with the data to be collected using either a computer interface, telephone, internet, directly from sensor, or from existing databases;
storing medical and other records being so collected in an information sharing repository which is electronically accessible;
employing an inference step to measure and compare actual incidence level of a particular event to its normal level
generating an alert when an emergency event is detected based upon the existence of a deviation from normal level to at least a predetermined level and
sending a message to a pre-defined set of persons.

20. A community based method where a patient can compare his medical record with summary information of patients with similar defined criteria, comprising the steps of:
inputting to a plurality of patients a set of medical and other inputs pertaining to the medical status of the patient
entering filter information for the viewing of patients with similar information, such as zip code and primary disease
reporting to said patient the summary information of patient with similar medical criteria and
reporting to said patient statistical information including deviation from median of information related to said patients primary disease in the requested population, and the corresponding parameter in the said patient's medical record.

21 The method in claim 20, further enhanced by offering said patient medical or other services that fit the medical criteria defined by that said patient.
